(19) United States
(12) Patent Application Publication
(10) Pub. No.: US 2012/0249900 A1
(43) Pub. Date: Oct. 4, 2012

(54) 3D IMAGE DISPLAY APPARATUS, PATTERNED POLARIZATION PLATE FOR 3D IMAGE DISPLAY APPARATUS, AND 3D IMAGE DISPLAY SYSTEM

(75) Inventors: Yoshio KOIKE, Kanagawa (JP); Koushin MATSUOKA, Kanagawa (JP)

(73) Assignee: FUJIFILM CORPORATION, Tokyo (JP)

(21) Appl. No.: 13/431,646

(22) Filed: Mar. 27, 2012

(30) Foreign Application Priority Data
Mar. 31, 2011 (JP) 2011-077783

(51) Int. Cl. G02F 1/1335; G02B 27/28; G02B 27/26

(52) U.S. Cl. 349/15; 359/462; 359/486.01

(57) ABSTRACT

A 3D image display apparatus has an image display panel; and a patterned polarization plate disposed on an observation side of the image display panel, in which the patterned polarization plate has at least a surface layer, a patterned optically anisotropic layer, and a linear polarization layer arranged sequentially from a surface on the observation side, the patterned polarization plate has at most one film between the surface layer and the patterned optically anisotropic layer and between the patterned optically anisotropic layer and the linear polarization layer respectively, the patterned polarization plate includes at most one adhesive layer, and the adhesive layer is provided between the image display panel and the patterned polarization plate.

### BACKGROUND OF THE INVENTION

1. Field of the Invention

The present invention relates to a patterned polarization plate for a 3D image display apparatus having an optically anisotropic layer with a high-definition pattern, a 3D image display apparatus using the same, and a 3D image display system.

2. Description of the Related Art

In a 3D image display apparatus that displays stereoscopic images, an optical member for making right-eye images and left-eye images into, for example, circularly polarized images in mutually opposite directions is required. For example, as such an optical member, a patterned phase difference plate is used in which areas having mutually different retarded axes, retardation, or the like are regularly disposed in the surface.

In order to manufacture a 3D image display apparatus in which the patterned phase difference plate is used, for example, it is necessary to adhere the patterned phase difference plate and a polarization plate or the patterned phase difference plate and a display panel, and high-definition alignment is required.

In addition, since high-definition alignment is required, workability for separating and then, again, adhering the two, that is, reworkability is required in a case in which location misalignment occurs while the two are adhered to each other.

For example, in JP4591591B, a method is proposed in which an image display panel, a polarization plate, a phase difference element, and an anti-reflection film are separately formed, and the respective members are adhered to each other using adhesive layers, thereby manufacturing an image display apparatus.

### SUMMARY OF THE INVENTION

However, in JP4591591B, since three adhesive layers, such as a first adhesive layer that adheres the image display panel and the polarization plate, a second adhesive layer that adheres the polarization plate and the phase difference element, and a third adhesive layer that adheres the phase difference element and the anti-reflection film, are required to manufacture an image display apparatus, there are problems in that the number of processes for manufacturing the image display apparatus increases, and the film thickness also increases. Therefore, there are problems in that it becomes difficult to achieve high-definition alignment, and the yield is degraded. In addition, since there are three adhesive layers, there is a problem in that optical characteristics deteriorate.

The invention has been made to solve the above problems, and an object of the invention is to reduce crosstalk caused by location misalignment of a patterned polarization plate in a 3D image display apparatus having a patterned polarization plate that has a patterned optically anisotropic layer with a fine pattern and a patterned polarization plate that is excellent in terms of reworkability.

Specifically, the object is to provide a patterned polarization plate for a 3D image display apparatus that is excellent in terms of reworkability, a 3D image display apparatus in which the patterned polarization plate is used to reduce crosstalk, and a 3D image display system.

Measures for solving the above problems are as follows:

[1] A 3D image display apparatus having an image display panel and a patterned polarization plate disposed on an observation side of the image display panel, in which the patterned polarization plate has at least a surface layer, a patterned optically anisotropic layer, and a linear polarization layer that are sequentially arrayed from an observation-side surface, the patterned polarization plate has at most one film between the surface layer and the patterned optically anisotropic layer and between the patterned optically anisotropic layer and the linear polarization layer respectively, the patterned polarization plate includes at most one adhesive layer, and the adhesive layer is provided between the image display panel and the patterned polarization plate.

[2] The 3D image display apparatus according to [1] having a film that supports the patterned optically anisotropic layer and the surface layer between the patterned optically anisotropic layer and the surface layer.

[3] The 3D image display apparatus according to [1] or [2] having a film that supports the patterned optically anisotropic layer and protects the linear polarization layer between the patterned optically anisotropic layer and the linear polarization layer.

[4] The 3D image display apparatus according to [1] or [2], in which neither a film nor an adhesive layer are present between the patterned optically anisotropic layer and the linear polarization layer.

[5] The 3D image display apparatus according to any one of [1] to [4], in which the patterned optically anisotropic layer includes first phase difference areas and second phase difference areas that have mutually different inner surface retarded axis directions, the first and second phase difference areas are alternately disposed in the surface of the patterned optically anisotropic layer, and, furthermore, the surface layer has the anti-reflection layer.

[6] The 3D image display apparatus according to [5], in which the inner surface retarded axis directions of the first and second phase difference areas cross orthogonally with respect to each other, and angles between the retarded axis directions of the first and second phase difference areas and an absorption axis direction of the linear polarization layer are ±45° respectively.

[7] The 3D image display apparatus according to any one of [1] to [6], in which left-eye video light and right-eye video light that have passed the patterned polarization plate are circularly polarized types of light rotated in mutually different directions.

[8] The 3D image display apparatus according to any one of [1] to [7], in which at most one film includes a cellulose derivative.

[9] The 3D image display apparatus according to any one of [1] to [8], in which at most one film satisfies the following formula (I).

0≦Re(550)≦10 (I)

In the formula (I), Re (550) indicates inner surface retardation at a wavelength of 550 nm.

[10] The 3D image display apparatus according to any one of [1] to [9], in which the patterned optically anisotropic layer is formed by fixing an orientation state of a composition including a liquid crystalline compound.

[11] The 3D image display apparatus according to any one of [1] to [10], in which the surface layer has an anti-reflection layer containing a fluorine compound.

[12] The 3D image display apparatus according to any one of [1] to [11] further having a light shielding portion for preventing left-eye videos and right-eye videos that are displayed on the image display panel from passing through a plurality of phase difference areas.

[13] The 3D image display apparatus according to any one of [1] to [12], in which the adhesive layer contains a polyol compound, and the glass transition temperature is room temperature or lower.

[14] The 3D image display apparatus according to any one of [1] to [13], in which the image display panel has a liquid crystalline cell.

[15] A patterned polarization plate for 3D image display apparatuses having at least a surface layer, a patterned optically anisotropic layer, a linear polarization layer, at most one film provided between the surface layer and the patterned optically anisotropic layer and between the patterned optically anisotropic layer and the linear polarization layer respectively, and at most one adhesive layer.

[16] A stereoscopic image display system having at least the 3D image display apparatus according to any one of [1] to [14] and a second polarization plate disposed on an observer side of the 3D image display apparatus, in which stereoscopic images are observed through the second polarization plate.

According to the invention, it is possible to reduce crosstalk caused by location misalignment of a patterned polarization plate in a 3D image display apparatus having the patterned polarization plate that has a patterned optically anisotropic layer with a fine pattern and a patterned polarization plate that is excellent in terms of reworkability.

Specifically, it is possible to provide a patterned polarization plate for a 3D image display apparatus that is excellent in terms of reworkability, a 3D image display apparatus in which the patterned polarization plate is used, and crosstalk is reduced, and a 3D image display system.

### BRIEF DESCRIPTION OF THE DRAWINGS

FIG. 1 is a schematic cross-sectional view showing an example of the 3D image display apparatus of the invention.

FIG. 2 is a schematic view of an example of the relationship between a polarization film and an optically anisotropic layer.

FIG. 3 is a schematic view of an example of the relationship between a polarization film and an optically anisotropic layer.

FIG. 4 is a schematic top surface view of an example of the patterned optically anisotropic layer according to the invention.

FIG. 5 is a schematic cross-sectional view showing an example of the cross section of a low refractive index layer.

FIG. 6 is a schematic cross-sectional view showing an example of the layer configuration of an anti-reflection film.

FIG. 7 is a schematic cross-sectional view showing an example of a 3D image display apparatus of the related art.

FIG. 8 is a schematic view used to explain the evaluation method that was carried out in Examples.

### DESCRIPTION OF THE PREFERRED EMBODIMENTS

Hereinafter, the invention will be described in detail. Meanwhile, in the present specification, the numerical ranges expressed using “to” refer to ranges that include numeric values specified before and after the “to” as the lower limit value and the upper limit value. Firstly, terminologies that will be used in the specification will be described.

In the specification, Re (λ) and Rth (λ) indicate the retardation in the surface and the retardation in the thickness direction at a wavelength of λ. Re (λ) is measured by making light rays having a wavelength of λ nm be incident in the normal direction to a film in a KOBRA 21ADH or WR (manufactured by Oji Scientific Instruments). The measurement wavelength λ nm can be selected by manually exchanging wavelength-selecting filters, or converting measured values using a program or the like.

In a case in which the measured film is expressed as a uniaxial or biaxial refractive index ellipsoid, the Rth (λ) is computed by the following method.

Re (λ) is measured at a total of six points by making light rays having a wavelength of λ nm be incident from directions inclined at 10 degree intervals from the normal direction to 50 degrees with respect to the normal direction to the film when retarded axes in the surface (determined using a KOBRA 21ADH or WR) are used as inclined axes (rotation axes) (in the case of no retarded axis, arbitrary directions in the film surface are used as the rotation axes), and Rth (λ) is computed using KOBRA 21ADH or WR based on the measured retardation values, an assumed value of the average refractive index, and the input film thickness value. In the above, in a case in which a film has a direction at which the retardation value becomes zero at an inclined angle when retarded axes in the surface from the normal direction are used as the rotation axes, the retardation values at inclined angles larger than the above inclined angle are changed to be negative values, and then the KOBRA 21ADH or WR computes Re (λ). Meanwhile, it is also possible to compute Rth by measuring retardation values from two arbitrary inclined angles when retarded axes are used as the inclined axes (rotation axes) (in the case of no retarded axis, arbitrary directions in the film surface are used as the rotation axes), and using the following formulae (1) and (2) based on the measured values, an assumed value of the average refractive index, and the input film thickness.

$$Re ( θ ) = [ nx - \frac{ny \times nz}{\sqrt{{( ny sin ( {sin}^{- 1} ( \frac{sin ( - θ )}{nx} ) ) )}^{2} + {( nz cos ( {sin}^{- 1} ( \frac{sin ( - θ )}{nx} ) ) )}^{2}}} ] \times \frac{d}{cos ( {sin}^{- 1} ( \frac{sin ( - θ )}{nx} ) )} \qquad [ Expression 1 ]$$

The above Re (θ) represents a retardation value in a direction inclined by θ degrees from the normal direction.

In the formula (1), nx represents the refractive index in the retarded axis direction in the surface, ny represents the refractive index in the orthogonal direction to nx in the surface, and nz represents the refractive index in the orthogonal direction to nx and ny. d represents the film thickness.

Rth=((nx+ny)/2−nz)×d Formula (2)

In the formula (2), nx represents the refractive index in the retarded axis direction in the surface, ny represents the refractive index in the orthogonal direction to nx in the surface, and nz represents the refractive index in the orthogonal direction to nx and ny. d represents the film thickness.

In a case in which a measured film does not have an axis that can be expressed as a uniaxial or biaxial refractive index ellipsoid, which is a so-called optical axis, Rth (λ) is computed by the following method. Re (λ) is measured at 11 points by making light rays having a wavelength of λ nm be incident from directions inclined at 10 degree intervals from −50 degrees to +50 degrees with respect to the normal direction to the film when retarded axes in the surface (determined using a KOBRA 21ADH or WR) are used as inclined axes (rotation axes), and Rth (λ) is computed using the KOBRA 21ADH or WR based on the measured retardation values, an assumed value of the average refractive index, and the input film thickness value. In addition, in the above measurement, values in the Polymer Handbook (JOHN WILEY & SONS, INC) and a variety of optical film catalogues can be used as the assumed value of the average refractive index. For films with no known average refractive index value, the refractive index value can be measured using an Abbe refractometer. The average refractive index values of principal optical films will be as follows: cellulose acylate (1.48), cycloolefin polymer (1.52), polycarbonate (1.59), polymethyl methacrylate (1.49), and polystyrene (1.59). When an assumed value of the average refractive index and a film thickness are input, a KOBRA 21ADH or WR computes nx, ny, and nz, and Nz=(nx−nz)/(nx−ny) is further computed using the computed nx, ny, and nz.

In addition, in the invention, the glass transition temperature (Tg) refers to a glass transition temperature obtained by differential scanning calorimetry (DSC). In addition, room temperature refers to 25° C. or lower.

In addition, in the specification, the terminology “polarization plate” is used as a collective term that refers to all of the linear polarization plate, a circularly polarized plate, and an ellipsoidal polarization plate.

The 3D image display apparatus of the invention is

a 3D image display apparatus having an image display panel and a patterned polarization plate disposed on an observation side of the image display panel,

in which the patterned polarization plate has at least a surface layer, a patterned optically anisotropic layer, and a linear polarization layer that are sequentially arrayed from an observation-side surface;

the patterned polarization plate has at most one film between the surface layer and the patterned optically anisotropic layer and between the patterned optically anisotropic layer and the linear polarization layer respectively;

the patterned polarization plate includes at most one adhesive layer; and

the adhesive layer is provided between the image display panel and the patterned polarization plate.

Generally, the surface layer and the patterned optically anisotropic layer are formed by coating on films respectively, and embodied in a display apparatus for every supporting body. In addition, the linear polarization layer is also, generally, embodied as a polarization plate having protective films laminated on both surfaces. That is, in general, the surface layer, the patterned optically anisotropic layer, and the linear polarization layer that compose the patterned polarization plate are manufactured as members that are separately integrated with the film respectively, and adhered through adhesive layers respectively, thereby manufacturing the patterned polarization plate. When the patterned polarization plate and the image display panel are adhered to each other, the patterned polarization plate and the image display panel need to be excellent in terms of workability for separating and re-attaching the patterned polarization plate and the image display panel in a case in which location misalignment occurs during the attachment, that is, reworkability. As a result of thorough studies by the inventors, it was found that, when the respective members are adhered to each other through the adhesive layers as in the related art, poor separation (remainders of peeled members remain attached to the display panel side) occurs in accordance with an increase of the number of layers, and reworkability is deteriorated. In the invention, the number of necessary adhesive layers is reduced, and reworkability is improved by making a single film function as a supporting body films for both the non-self-supporting surface layer and the patterned optically anisotropic layer, or making a single film function as both a protective film for the linear polarization layer and a supporting body film for the patterned optically anisotropic layer. In addition, the reduction of the number of necessary adhesive layers decreases the film thickness. Therefore, it is possible to stably provide a crosstalk-free 3D image display apparatus at high productivity.

In addition, the reduction of the number of necessary adhesive layers decreases the number of manufacturing processes and leads to a decrease in costs.

In the patterned polymerization plate according to the invention, at most only one film is disposed between the surface layer and the patterned optically anisotropic layer, and between the patterned optically anisotropic layer and the linear polarization layer respectively, and two or more films are not disposed. No film may be provided between the surface layer and the patterned optically anisotropic layer, and between the patterned optically anisotropic layer and the linear polarization layer. For example, a laminate obtained by forming the surface layer on one surface of a film and the patterned optically anisotropic layer on the other surface may be used as a protective film for the linear polarization layer, and, in this aspect, no film is present between the patterned optically anisotropic layer and the linear polarization layer.

In addition, the patterned polarization plate may include other layers formed by coating, and, for example, may also have an oriented film used for formation of the patterned optically anisotropic layer.

The 3D image display apparatus of the invention has the image display panel and the patterned polarization plate. The patterned polarization plate is disposed on the observation side of the image display panel, and has a function of converting images displayed on the image display panel to polarized images, such as right-eye and left-eye circularly polarized images or linearly polarized images. An observer observes the images through the polarization plate, such as circularly polarized or linearly polarized glasses, and recognizes the images stereoscopically. In addition, the image display panel and the patterned polarization plate are attached to each other through the adhesive layer.

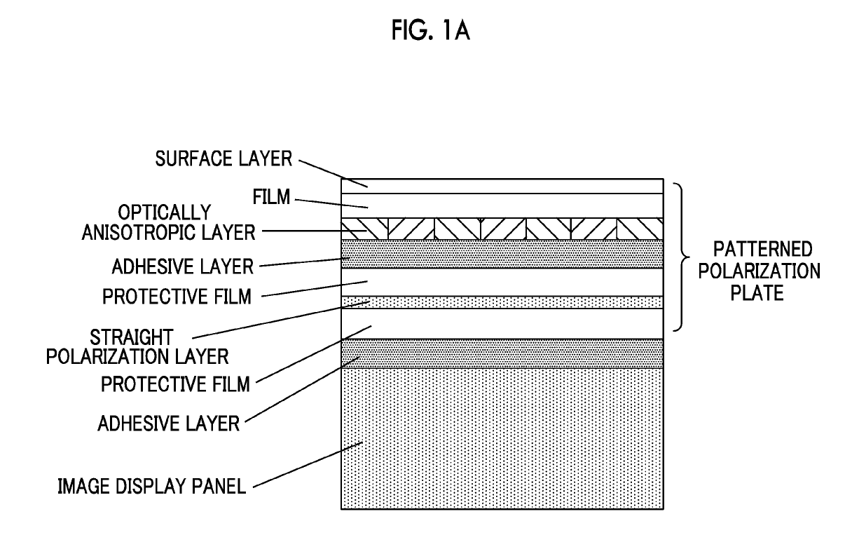

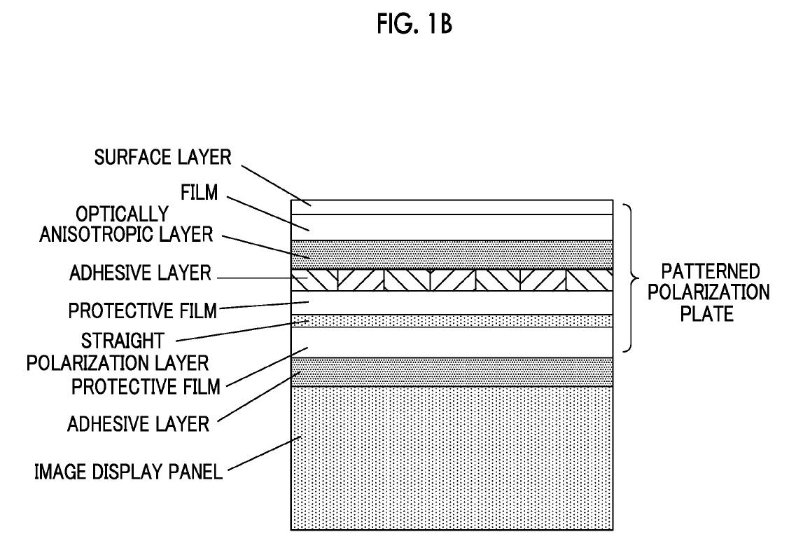

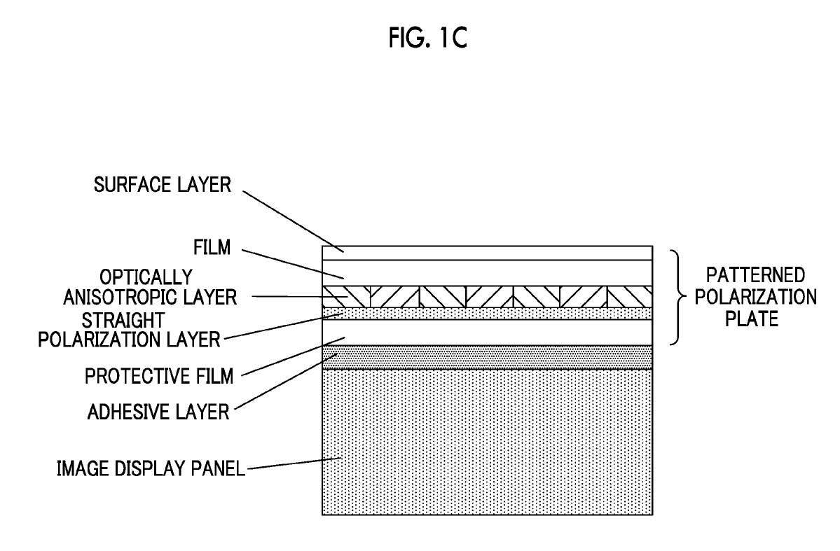

A schematic cross-sectional view of an example of the 3D image display apparatus of the invention is shown in FIG. 1A. Meanwhile, in the drawing, the relative relationship of the thickness between the respective layers is not necessarily coincident with the actual relative relationship of the thickness between the respective layers.

In the example as shown in FIG. 1A, only one film is disposed between the surface layer and the patterned optically anisotropic layer, and the film is used as a supporting body film for both the surface layer and the patterned optically anisotropic layer. When a polarization plate having protective films on both surfaces is adhered to the laminate (a laminate having the surface layer, the film, and the patterned optically anisotropic layer), the protective films of the polarization plate and the patterned optically anisotropic layer may be adhered to each other using an adhesive, that is, the patterned polarization plate has only one adhesive layer between the protective film of the linear polarization layer and the patterned optically anisotropic layer in the example as shown in FIG. 1A. The phase difference plate may include other members, and an oriented film may be provided between the film and the patterned optically anisotropic layer in the example as shown in FIG. 1A.

In the example as shown in FIG. 1B, only one film is disposed between the patterned optically anisotropic layer and the linear polarization layer, and the film is used as a supporting body film for the patterned optically anisotropic layer and a protective film for the linear polarization layer. When the linear polarization layer and the polarization plate having protective films on both surfaces and, furthermore, the patterned optically anisotropic layers thereon are adhered to the surface film on which the surface layer is formed, the patterned optically anisotropic layer of the polarization plate and the rear surface of the surface film (the surface having no surface layer formed thereon) may be adhered to each other using an adhesive, that is, the patterned polarization plate has only one adhesive layer between the patterned optically anisotropic layer and the supporting body film of the surface layer in the example as shown in FIG. 1B.

In the example as shown in FIG. 1C, only one film is disposed between the surface layer and the patterned optically anisotropic layer, and the film is used as a supporting body film for both the surface layer and the patterned optically anisotropic layer. On the other hand, no film is present between the patterned optically anisotropic layer and the linear polarization layer, and the linear polarization layer is laminated on the surface of the patterned optically anisotropic layer. In the example as shown in FIG. 1C, when the linear polarization layer and the polarization plate having a protective film on one surface are adhered to a laminate having the surface layer, the film, and the patterned optically anisotropic layer, the layer and the plate can be adhered to each other without an adhesive, that is, the patterned polarization plate includes no adhesive.

In the invention, the patterned polarization plate is disposed on the observation side of the image display panel, and polarized images that have passed through the patterned polarization plate are recognized as right-eye and left-eye images through polarized glasses or the like. The right-eye and left-eye images are formed based on the pattern of the patterned optically anisotropic layer included in the patterned polarization plate. Therefore, the first and second phase difference areas that configure the patterned optically anisotropic layer preferably have mutually the same shape so as to prevent left and right images from becoming uneven, and the first and second phase difference areas are preferably disposed evenly and symmetrically.

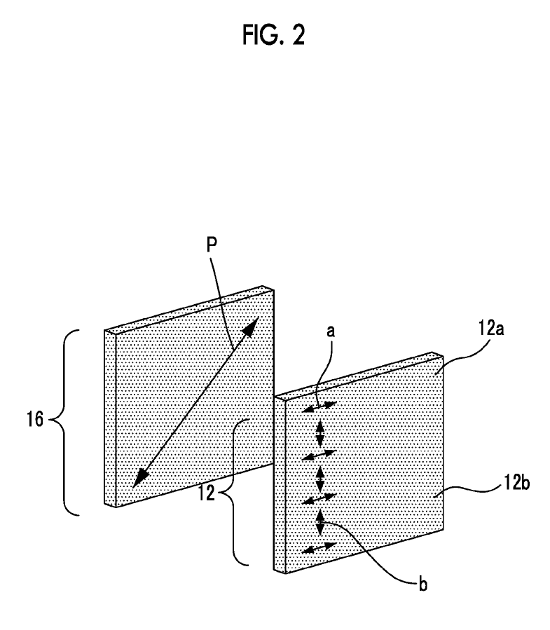

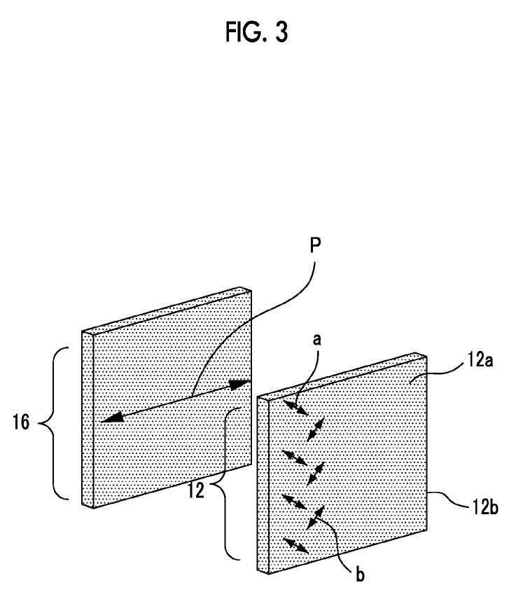

The patterned optically anisotropic layer has the first and second phase difference areas in which the inner surface retarded axes are in mutually different directions or the inner surface retardations are mutually different. An example is an optically anisotropic layer in which the inner surface retardations of the first and second phase difference areas are approximately λ/4 respectively, and the inner surface retarded axes cross orthogonally with respect to each other respectively. In this example, the optically anisotropic layer 12 is disposed so that the inner surface retarded axes a and b of the first and second phase difference areas 12a and 12b are at ±45° with respect to the transmission axis P of the linear polarization layer 16 as shown in FIGS. 2 and 3. In the specification, it is not necessary for both the first and second phase difference areas 12a and 12b to be strictly at ±45°, but one is preferably at 40° to 50°, and the other is preferably at −50° to −40°. This configuration enables separation of right-eye and left-eye circularly polarized images. In addition, the view angle may be further enlarged by further laminating a λ/2 plate.

Circularly polarized images can also be separated similarly by using an optically anisotropic layer in which one of the first and second phase difference areas 12a and 12b has an inner surface retardation of λ/4, and the other has an inner surface retardation of 3λ/4.

Furthermore, circularly polarized images can also be separated similarly by using an optically anisotropic layer in which one of the first and second phase difference areas 12a and 12b has an inner surface retardation of λ/2, and the other has an inner surface retardation of 0, and laminating the optically anisotropic layer so that a transparent supporting body having an inner surface retardation of λ/4 and the respective retarded axes are in parallel or cross orthogonally with respect to each other.

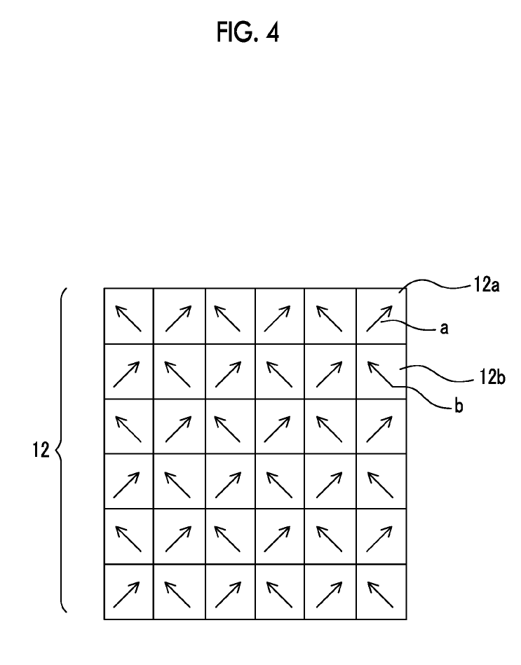

In addition, the shape and disposition pattern of the first and second phase difference areas 12a and 12b are not limited to an aspect in which the stripe patterns as shown in FIGS. 2 and 3 are alternately disposed. Rectangular patterns may be disposed in a grid shape as shown in FIG. 4.

The patterned optically anisotropic layer may be a single layer structure or a laminate structure of two or more layers. The patterned optically anisotropic layer can be formed of one or two kinds of compositions having a liquid crystalline compound that has a polymerizable group as a main component. The patterned optically anisotropic layer is preferably formed by setting the compositions in a desired orientation state, and fixing the orientation state through a polymerization reaction. It is possible to use a horizontal orientation, a vertical orientation, a hybrid orientation, and the like according to desired optical characteristics. The λ/4 layer can be stably formed by fixing rod-shaped liquid crystals in a horizontal orientation state. In addition, the λ/4 layer can be stably formed by fixing discotic liquid crystals in a vertical orientation state. Meanwhile, in the specification, the “vertical orientation” indicates that, for example, the disc surface of the discotic liquid crystal and the layer surface are vertical to each other in a case in which the liquid crystalline compound is a discotic liquid crystal. In the specification, the vertical orientation does not require the disc surface of the discotic liquid crystal and the layer surface to be strictly vertical to each other, and means that the inclination angle formed with respect to the horizontal surface is 70 degrees or more. The inclination angle is preferably 85 degrees to 90 degrees, more preferably 87 degrees to 90 degrees, still more preferably 88 degrees to 90 degrees, and most preferably 89 degrees to 90 degrees. In addition, the patterned optically anisotropic layer may also contain an orientation controlling agent that controls the orientation of the liquid crystalline compound in the composition. The details of the liquid crystalline compound and the orientation controlling agent will be described below.

In addition, the inner surface retarded axes of the respective patters of the optically anisotropic layer can be adjusted to mutually different directions, for example, mutually orthogonal directions, by using a pattern oriented film or the like. Any of light oriented films that can form a patterning oriented film through mask exposure and rubbing oriented films that can form a patterning oriented film through mask rubbing can also be used as the patterned oriented film. In addition, it is also possible to use an orientation control technology using nanoimprint instead of using the patterned oriented film. The orientation control technology using nanoimprint is a technology in which plural kinds of microstructures are formed by a nano print technology, and orientation is controlled by the shape, or a technology in which the mold of nanoimprint is oriented, and an optically anisotropic layer that has been in a desired orientation state is directly print-transferred. The orientation control technology using nano print is described in JP4547641B and the like, which can be referenced.

The surface layer included in the patterned polarization plate may be a single layer structure or a laminate structure of two or more layers. The surface layer preferably includes an anti-reflection layer that prevents reflected glare of external light, an ultraviolet absorption layer that is exposed to external light so as to prevent degradation, and the like.

The linear polarization layer included in the patterned polarization plate may be composed of a stretched film or may be a layer formed by coating. The former example includes films obtained by dyeing a stretched polyvinyl alcohol film using iodine, a dichromatic dye, or the like. The latter example includes a layer fixed in a predetermined orientation state which is obtained by coating a composition including a dichromatic liquid crystalline colorant.

The film included in the pattern polymerization plate of the invention may be optically isotropic or anisotropic. It is preferable to use an optically isotropic film, specifically, a film having a Re (550) of 10 nm or less and a Rth (550) of 20 nm or less. It is needless to say that an optically anisotropic phase difference film may also be used. In the above aspect, the total Re of all members included in the patterned polarization plate is preferably in a desired range, for example, in an aspect of a pattern circularly polarized plate, the total Re of all members is preferably 110 nm to 145 nm, more preferably 115 nm to 140 nm, and particularly preferably 120 nm to 135 nm.

Examples of materials forming a film that can be used in the invention include polycarbonate-based polymers, polyester-based polymers, such as polyethylene terephthalate and polyethylene naphthalate, acryl-based polymers, such as polymethyl methacrylate, styrene-based polymers, such as polystyrene and acrylonitrile styrene copolymers (AS resin), and the like. In addition, the examples also include polyolefins, such as polyethylene and polypropylene, polyolefin-based polymers, such as ethylene propylene copolymers, vinyl chloride-based polymers, amide-based polymers, such as nylon and aromatic polyamide, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, vinyl alcohol-based polymers, vinyl butyral-based polymers, arylate-based polymers, polyoxy methylene-based polymers, epoxy-based polymers, and mixtures of polymers. In addition, the polymer film of the invention can be formed as a cured layer of an acryl-based, urethane-based, acryl urethane-based, epoxy-based, silicone-based, or other ultraviolet curable or thermosetting resin.

In addition, it is possible to preferably use a thermoplastic norbornene-based resin as a material that forms the film. The thermoplastic norbornene-based resin includes ZEONEX, and ZEONOR, manufactured by Zeon Corporation, ARTON, manufactured by JSR Corporation, and the like.

In addition, as a material that forms the film, cellulose-based polymers that were used as a transparent protective film of a polarization plate of the related art can be used, and, among them, cellulose acylate which is represented by triacetyl cellulose (hereinafter referred to as TAC) can be more preferably used.

The thickness of the film is preferably 10 μm to 120 μm, more preferably 20 μm to 100 μm, and still more preferably 30 μm to 90 μm.

In the invention, there is no limitation on the image display panel. The image display panel may be, for example, a liquid crystal panel including a liquid crystal layer, an organic EL display panel including an organic EL layer, or a plasma display panel. In any aspect, a variety of available configurations can be employed. In addition, in the case of a liquid crystal panel in a transparent mode, or the like, in an aspect having a polarization film for image display on the observation-side surface, the linear polarization layer included in the patterned polarization plate of the invention may also be used for image display of the image display panel. That is, the linear polarization layer can also function similarly as the polarization plate on the observation side of the liquid crystal display apparatus.

In an aspect in which an image display panel is a liquid crystal display panel, the configuration of the liquid crystalline cell is not particularly limited, and a liquid crystalline cell having an ordinary configuration can be employed. The liquid crystalline cell includes, for example, a pair of substrates disposed opposite, not shown, and a liquid crystal layer sandwiched between the pair of substrates, and may include a color filter layer and the like, if necessary. The driving mode of the liquid crystalline cell is also not particularly limited, and a variety of modes, such as a twisted nematic (TN) mode, a super twisted nematic (STN) mode, a vertical alignment (VA) mode, an in-plane switching (IPS) mode, and an optically compensated birefringence (OCB) mode, can be used. In the TN mode, generally, the transmission axis of the polarization film is disposed at 45° or 135° with respect to 0° in the right and left directions of the display surface, and therefore a liquid crystal panel in the TN mode is preferably combined with a phase difference plate of the aspect as shown in FIG. 2. In addition, in the VA mode and the IPS mode, generally, the transmission axis of the polarization film is disposed at 0° or 90° with respect to 0° in the right and left directions of the display surface, and therefore a liquid crystal panels in the VA mode or the IPS mode is preferably combined with a phase difference plate of the aspect as shown in FIG. 3.

The invention also relates to a 3D image display system. The 3D image display system of the invention has at least the 3D image display apparatus of the invention and the second polarization plate disposed on the observer side of the 3D image display apparatus, and is a stereoscopic image display system in which stereoscopic images are observed through the second polarization plate. In an aspect in which the patterned polarization plate is a pattern circularly polarized plate, the second polarization plate is a circularly polarized plate having a λ/4 layer, and preferably circularly polarized glasses in which circularly polarized plates having mutually different directions are disposed for the right eye and the left eye.

Hereinafter, a variety of members used in the 3D image display apparatus of the invention will be described in detail.

<Adhesive Layer>

The 3D image display apparatus of the invention has an adhesive layer to adhere the patterned polarization plate and the image display panel. In addition, the patterned polarization plate has at most one adhesive layer. The patterned polarization plate may not have the adhesive layer. The adhesive layer included in the patterned polarization plate and the adhesive layer for adhering the patterned polarization plate and the image display panel may be composed of mutually the same adhesive composition or mutually different adhesive compositions. In addition, in the specification, the terminology “adhesive” is used as a collective term including all chemicals that are ordinarily classified as “adhesives.” Meanwhile, the linear polarization layer needs to be attached to the protective film or the optically anisotropic layer through an adhesive, and the layer including an adhesive includes not only the adhesive layer but also the linear polarization layer. That is, in a case in which a PVA linear polarization layer is attached using a PVA adhesive, the PVA adhesive is not considered as the adhesive layer.

Examples of materials of the adhesive layer that can be used in the invention include substances for which the ratio of G′ to G″ (tan δ=G″/G′) that is measured using a dynamic viscoelastic measurement apparatus is 0.001 to 1.5, in other words, adhesives, easily-creeping substances, and the like. The adhesive is not particularly limited, and examples of the adhesive that can be used include polyvinyl alcohol-based adhesives and adhesives for which the glass transition temperature is room temperature or lower, and an adhesive layer including an adhesive for which the glass transition temperature is room temperature or lower can be preferably used from the viewpoint of reworkability or adhesion properties.

Hereinafter, the adhesive for which the glass transition temperature is room temperature or lower will be described.

The glass transition temperature of the adhesive is preferably room temperature or lower, more preferably −15° C. or lower, and still more preferably −30° C. or lower. When the glass transition temperature of the adhesive exceeds room temperature, it becomes difficult to make the adhesive correspondingly respond to dimensional changes of the film.

In the invention, it is also possible to use the storage elastic modulus as the hardness index of the adhesive composition, similarly to the glass transition temperature. The storage elastic modulus of the adhesive composition by the shear mode at 30° C. is preferably 1000 kPa or less, more preferably 500 kPa or less, and still more preferably 400 kPa or less. In addition, the storage elastic modulus of the adhesive composition is preferably 1 kPa or more from the viewpoint of the storage stability. That is, the storage elastic modulus of the adhesive composition is preferably in a range of 1000 kPa to 1 kPa, more preferably 500 kPa to 10 KPa, and still more preferably 400 kPa to 20 KPa. The storage elastic modulus can be obtained from dynamic viscoelastic behaviors obtained from measurements at 1 Hz using a dynamic viscoelastic measurement apparatus (for example, DVA-200, manufactured by IT Keisoku Seigyo Co., Ltd.). Furthermore, the loss tangent (tan δ) obtained by dynamic viscoelastic behaviors is preferably in a range of 1.0 to 0.003, more preferably in a range of 0.9 to 0.0035, and still more preferably in a range of 0.6 to 0.004 when measured at a frequency of 1 Hz and 30° C. in a tensile mode or shear mode.

As the adhesive, an adhesive that is liquid at room temperature to 40° C. is preferably used. It is preferable not to use a solvent, and, even when a solvent is used, the amount thereof preferably remains extremely small. The adhesive composition has a viscosity at a temperature of 25° C. of 0.1 cP to 1000 cP (0.1 mPa·s to 1000 mPa·s), more preferably 1 mPa·s to 100 mPa·s, and still more preferably 5 mPa·s to 50 mPa·s since alignment is possible without moving the phase difference plate and injecting air bubbles.

In addition, for viscosity adjustment, a polymer having a mass average molecular weight of 10000 or more can be used as the adhesive. In order to obtain a desired viscosity by adding a small amount of the adhesive, a polymer having a large molecular weight, that is, a polymer having a mass average molecular weight of 100000 or more is preferably used, and a polymer having a mass average molecular weight of one million or more is more preferably used. However, it is also possible to produce an adhesive composition having a preferable viscosity without using an adhesive by using a urethane (meth)acrylate-based macropolymer having, for example, the above preferable glass transition temperature, the preferable mass average molecular weight as described below, or the like.

In the invention, when the adhesive composition is formed of an ultraviolet curable composition which is cured by ultraviolet rays, an apparatus used for adhering the phase difference plate and the display panel becomes simple, furthermore, adhesion time can be shortened, and the adhesive composition can be manufactured at low cost. Thereby, the productivity can be improved. In addition, when an ultraviolet curable composition containing a urethane (meth)acrylate-based macromonomer is used as the ultraviolet curable composition, the adhesion force can be increased in spite of the low glass transition temperature. As described above, the adhesion force is decreased as the Tg of the ultraviolet curable composition of the related art is decreased. Polymers having a low glass transition temperature refer to polymers in which the intermolecular rotation of high molecular main chains is liable to occur due to micro Brownian motion, in other words, polymers having large free volumes around high molecular main chains. Due to the above, ordinarily, polymers having a low glass transition temperature have a weak cohesion force and a weak adhesion force. That is, when monomers for which the glass transition temperature is expected to be lowered are polymerized, it becomes possible to produce an adhesive composition having a weak cohesion force and a weak adhesion force. In contrast to the above, it is an extremely surprising fact that an ultraviolet curable composition having a strong adhesion force can be obtained by a urethane (meth)acrylate-based macromonomer being contained in spite of a low glass transition temperature.

In the invention, “(meth)acrylate” refers to chemicals including esters of an acrylic acid (acrylates) and esters of a methacrylic acid (methacrylates), and “urethane (meth)acrylate-based macromonomer” refers to urethane (meth)acrylates having a mass average molecular weight of 100 to 1×10⁷, and preferably urethane (meth)acrylates having a mass average molecular weight of 1000 to 1×10⁶, and more preferably 10000 to 100000.

The urethane (meth)acrylate-based macromonomer is preferably a monofunctional to pentafunctional macromonomer, more preferably a tetrafunctional macromonomer, and still more preferably a bifunctional to trifunctional macromonomer.

In addition, in order to produce an ultraviolet curable composition having favorable coating aptitude, it is preferable to use a macromonomer having a glass transition temperature of −10° C. or lower as the urethane (meth)acrylate-based macromonomer. When a macromonomer having a glass transition temperature of −10° C. or lower is used, an ultraviolet curable composition having an appropriate viscosity and favorable coating aptitude can be produced. The glass transition temperature of the urethane (meth)acrylate-based macromonomer is more preferably −15° C. to −100° C., and still more preferably −20° C. to −90° C.

The mass average molecular weight of the urethane (meth)acrylate-based macromonomer is preferably 100 to 1×10⁷, more preferably 1000 to 1×10⁶, and still more preferably 10000 to 100000. When the mass average molecular weight is in the above ranges, the ultraviolet curable composition having a preferable viscosity can be produced, and, furthermore, an ultraviolet curable composition having a glass transition temperature in a desired range after curing can be produced.

The urethane (meth)acrylate-based macromonomer can be produced by causing a reaction of a polyol compound, a polyisocyanate compound, and a hydroxyl group-containing (meth)acrylate compound. Alternately, the urethane (meth)acrylate-based macromonomer can be obtained from commercially available products. The commercially available products include urethane acrylate EBECRYL-230 (bifunctional, mass average molecular weight of 5000 (value from the catalog of manufacturer), Tg; −55° C.), EBECRYL-270 (bifunctional, mass average molecular weight of 1500, Tg; −27° C.), KRM8296 (trifunctional, Tg; −11° C.), all of which are manufactured by Daicel-Cytec Company Ltd., and the like, but the invention is not limited thereto.

Hereinafter, the respective components that can be used as raw materials of the urethane (meth)acrylate-based macromonomer will be described.

(i) Polyol Compound

As the polyol compound, polyether polyols, polyester polyols, polycarbonate polyols, polycaprolactone polyols, aliphatic hydrocarbons having two or more hydroxyl groups in the molecules, alicyclic hydrocarbons having two or more hydroxyl group in the molecules, unsaturated hydrocarbons having two or more hydroxyl groups in the molecules, and the like can be used. The polyol can be used singly or jointly used in combination of two or more kinds.

The polyether polyols include aliphatic polyether polyols, polycyclic polyether polyols, and aromatic polyether polyols.

Here, examples of the aromatic polyether polyols include multivalent alcohols, such as polyethylene glycol, polypropylene glycol, polytetramethylene glycol, polyhexamethylene glycol, polyheptamethylene glycol, polydecamethylene glycol, pentaerythritol, dipentaerythritol, trimethylolpropane, alkylene oxide adducts of polyols, such as ethylene oxide adducts of triols of trimethylolpropane, propylene oxide adducts of triols of trimethylolpropane, ethylene oxide and propylene oxide adducts of triols of trimethylolpropane, ethylene oxide adducts of tetraols of pentaerythritol, ethylene oxide adducts of tetraols of pentaerythritol, and ethylene oxide adducts of hexaols of dipentaerythritol, and polyether polyols obtained by open-ring polymerization of two or more kinds of ion-polymerizable cyclic compounds.

Examples of the ion-polymerizable cyclic compounds include cyclic ethers, such as ethylene oxide, propylene oxide, butene-1-oxide, isobutene oxide, 3,3-bis(chloromethyl)oxetane, tetrahydrofuran, 2-methyltetrahydrofuran, dioxane, trioxane, tetraoxane, cyclohexene oxide, styrene oxide, epichlorohydrin, glycidyl ether, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, glycidyl benzoate, and the like. Specific combinations of two or more kinds of ion-polymerizable cyclic compounds include tetrahydrofuran and ethylene oxide, tetrahydrofuran and propylene oxide, tetrahydrofuran and 2-methyltetrahydrofuran, tetrahydrofuran and 3-methyltetrahydrofuran, ethylene oxide and propylene oxide, butene-1-oxide and ethylene oxide, tetrahydrofuran, butene-1-oxide, and ethylene oxide, and the like.

In addition, it is also possible to use a polyether polyol obtained by ring-opening copolymerization of the ion-polymerizable cyclic compound and a cyclic imine, such as ethyleneimine, a cyclic lactonic acid, such as β-propiolactone or glycolic acid lactide, or a dimethylcyclopolysiloxane.

Examples of the aliphatic polyether polyols include alkylene oxide adductdiols of hydrogenated bisphenol A, alkylene oxide adductdiols of hydrogenated bisphenol F, alkylene oxide adductdiols of 1,4-cyclohexanediol, and the like.

Examples of the aromatic polyether polyols include alkylene oxide adductdiols of bisphenol A, alkylene oxide adductdiols of bisphenol F, alkylene oxide adductdiols of hydroquinone, alkylene oxide adductdiols of naphthohydroquinone, alkylene oxide adductdiols of anthrahydroquinone, and the like.

Examples of the commercially available products of the aliphatic polyether polyols include PTMG650, PTMG1000, PTMG2000 (all manufactured by Mitsubishi Chemical Corp.), PPG1000, EXCENOL1020, EXCENOL2020, EXCENOL3020, EXCENOL4020 (all manufactured by Asahi Glass Urethane Co., Ltd.), PEG1000, UNISAFE DC1100, UNISAFE DC1800, UNISAFE DCB1100, UNISAFE DCB1800 (all manufactured by Nippon Oil and Fats Co., Ltd.), PPTG1000, PPTG2000, PPTG4000, PTG400, PTG650, PTG2000, PTG3000, PTGL1000, PTGL2000 (all manufactured by Hodogaya Chemical Co., Ltd.), PPG400, PBG400, Z-3001-4, Z-3001-5, PBG2000, PBG2000B (all manufactured by Daiichi Kogyo Seiyaku Co., Ltd.), TMP30, PNT4 GLYCOL, EDA P4, EDA P8 (all manufactured by Nippon Nyukazai Co., Ltd.), and QUADROL (manufactured by Adeka Corporation). Examples of the commercially available products of the aromatic polyether polyols include UNIOL DA400, DA700, DA1000, DB400 (all manufactured by Nippon Oil and Fats Co., Ltd.), and the like.

In addition, the polyester polyol can be obtained by reacting a multivalent alcohol and a dibasic acid. Here, the multivalent alcohol includes ethylene glycol, polyethylene glycol, propylene glycol, polypropylene glycol, tetramethylene glycol, polytetramethylene glycol, 1,4-butanediol, 1,5-pentanediol, 1,6-hexanediol, 1,7-heptanediol, 1,8-octanediol, neopentyl glycol, 1,4-cyclohexanediol, 1,4-cyclohexanedimethanol, 1,2-bis(hydroxyethyl)cychlohexane, 2,2-diethyl-1,3-propanediol, 3-methyl-1,5-pentane polyol, 1,9-nonane polyol, 2-methyl-1,8-octane polyol, glycerin, trimethylolpropane, trimethylolpropane, ethylene oxide adducts of trimethylolpropane, propylene oxide adducts of trimethylolpropane, adducts of an ethylene oxide of trimethylolpropane and propylene oxide, sorbitol, pentaerythritol, dipentaerythritol, alkylene oxide adducts of polyols, and the like. In addition, examples of the dibasic acid include phthalic acids, isophthalic acids, terephthalic acids, maleic acids, fumaric acids, adipic acids, sebacic acids; and the like. The commercially available products of the polyester polyol which can be used include KURAPOL P1010, KURAPOL P2010, PMIPA, PKA-A, PKA-A2, PNA-2000 (manufactured by Kuraray Co., Ltd.), and the like.

In addition, examples of the polycarbonate polyol include polycarbonatediols represented by the following general formula (1).

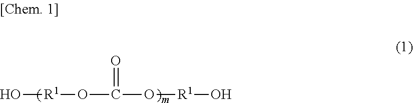

In the general formula (1), R′ represents an alkyl group, a (poly)ethylene glycol residue, a (poly)propylene glycol residue, or a (poly)tetramethylene glycol residue which has 2 to 20 carbon atoms, and m represents an integer in a range of 1 to 30.

Specific examples of R¹ include residues obtained by removing hydroxyl groups at both ends from the following compounds, that is, residues obtained by removing hydroxyl groups from 1,4-butanediol, 1,5-pentanediol, neopentyl glycol, 1,6-hexanediol, 1,4-cyclohexane dimethanol, 1,7-heptanediol, 1,8-octanediol, 1,9-nonanediol, ethylene glycol, diethylene glycol, triethylene glycol, tetraethylene glycol, propylene glycol, dipropylene glycol, tripropylene glycol, tetrapropylene glycol, and the like. Commercially available products of the polycarbonate polyol include DN-980, DN-981, DN-982, DN-983 (all manufactured by Nippon Polyurethane Industry Co., Ltd.), PC-8000 (manufactured by PPG), PNOC1000, PNOC2000, PMC100, PMC2000 (all manufactured by Kuraray Co., Ltd.), PLACCEL CD-205, CD-208, CD-210, CD-220, CD-205PL, CD-208PL, CD-210PL, CD-220PL, CD-205HL, CD-208HL, CD-210HL, CD-220HL, CD-210T, CD-221T (all manufactured by Diacel Corporation), and the like.

The polycaprolactone polyol includes polycaprolactonediols obtained by causing an addition reaction of ∈-caprolactone in adiol, such as ethylene glycol, polyethylene glycol, polytetramethylene glycol, 1,2-polybutylene glycol, 1,6-hexanediol, neopentyl glycol, 1,4-cyclohexanedimethanol, or 1,4-butanediol. The commercially available products thereof that can be used include PLACCEL 205, 205AL, 212, 212AL, 220, 220AL (all manufactured by Daicel Chemical Industries, Ltd.), and the like.

The aliphatic hydrocarbon having two or more hydroxyl group in the molecules include ethylene glycol, propylene glycol, 1,4-butanediol, 1,5-pentanediol, 1,6-hexanediol, 1,7-heptanediol, 1,8-octanediol, 1,9-nonanediol, neopentyl glycol, 2,2-diethyl-1,3-propanediol, 3-methyl-1,5-pentanediol, 2-methyl-1,3-propanediol, 3-methyl-1,5-pentanediol, 2-methyl-1,8-octanediol, hydroxy-terminated hydrogenated polybutadiene, glycerin, trimethylolpropane, pentaerythritol, sorbitol, and the like.

Examples of the alicyclic hydrocarbon having two or more hydroxyl group in the molecules include 1,4-cyclohexanediol, 1,4-cyclohexane dimethanol, 1,2-bis(hydroxyethyl)cyclohexane, methylol compounds of dicyclopentadiene, tricyclodecane dimethanol, and the like.

Examples of the unsaturated hydrocarbon having two or more hydroxyl group in the molecules include hydroxyl-terminated polybutadiene, hydroxyl-terminated polyisoprene, and the like.

Furthermore, examples of other polyols include β-methyl-δ-valerolactonediol, ricinus-modified diol, terminated diol compounds of polydimethylsiloxane, polydimethylsiloxane carbitol-modified diol, and the like.

The mass average molecular weight of the polyol compound is preferably 1000 to 10000, and particularly preferably 1000 to 9000. The mass average molecular weight is a value obtained by dissolving a part of a polymer in tetrahydrofuran (THF) and measuring a molecular weight using gel permeation chromatography (GPC). In the invention, the mass average molecular weight is a value for which polystyrene is used as a standard substance.

The most preferable polyol compound includes polypropylene glycol in terms of solubility.

(ii) Polyisocyanate Compound

Diisocyanate compounds are preferable as the polyisocyanate compound, and examples thereof include 2,4-tolylene diisocyanate, 2,6-tolylene diisocyanate, 1,3-xylene diisocyanate, 1,4-xylene diisocyanate, 1,5-naphthalene diisocyanate, m-phenyl diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone dicyanate, 2,2,4-trimethylhexamethylene diisocyanate, bis(2-isocyanate ethyl)fumarate, 6-isopropyl-1,3-phenyl diisocyanate, 4-diphenylpropane diisocyanate, lysine isocyanate, hydrogenated diphenylmethane diisocyanate (for example, 4,4′-dicyclohexyl diisocyanate, and the like), hydrogenated xylene diisocyanate, tetramethyl xylene diisocyanate, and the like. Among them, 2,4-tolylene diisocyanate, 2,6-tolylene diisocyanate, hydrogenated xylene diisocyanate, isophorone dicyanate, hydrogenated diphenylethane diisocyanate, and the like are particularly preferred. The diisocyanate can be used singly or in combination of two or more kinds.

(iii) Hydroxyl Group-Containing (Meth)Acrylate Compound

The hydroxyl group-containing (meth)acrylate compound is a (meth)acrylate having a hydroxyl group at an ester residue, that is, a monohydroxy (meth)acrylate obtained by causing a reaction of a bifunctional alcohol, such as ethylene glycol, 1,3-butylene glycol, 1,4-butanediol, 1,5-pentanediol, 3-methyl-1,5-pentanediol, 1,6-hexanediol, neopentyl glycol, 1,8-octanediol, 1,9-nonanediol, tricyclodecane dimethanole, ethylene glycol, polyethylene glycol (the mass average molecular weight is, for example, 200 to 9000, preferably 1000 to 9000, and more preferably 2000 to 8000), propylene glycol, dipropylene glycol, tripropylene glycol, or polypropylene glycol (the mass average molecular weight is, for example, 200 to 9000, preferably 1000 to 9000, and more preferably 2000 to 8000), with (meth)acrylic acid. Examples thereof include 2-hydroxy ethyl (meth)acrylate, 2-hydroxy propyl (meth)acrylate, 4-hydroxy butyl (meth)acrylate, 2-hydroxy-3-phenyloxy propyl (meth)acrylate, 1,4-butanediol mono(meth)acrylate, 2-hydroxy alkyl (meth)acryloyl phosphate, 4-hydroxy cyclohexyl (meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, (meth)acrylates represented by the following structural formula (2), and the like.

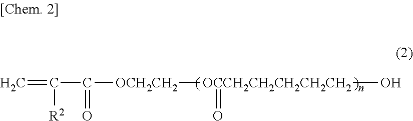

[In the general formula (2), R² represents a hydrogen atom or a methyl group, and n represents an integer in a range of 1 to 15, and preferably 1 to 4.] Furthermore, examples thereof also include compounds obtained by an addition reaction of a glycidyl group-containing compound, such as alkyl glycidyl ether, allyl glycidyl ether, or glycidyl (meth)acrylate, and (meth)acrylic acid. Among them, hydroxyl alkyl (meth)acrylates, such as 2-hydroxy ethyl (meth)acrylate, 2-hydroxy propyl (meth)acrylate, and 4-hydroxy butyl (meth)acrylate, are particularly preferred.

A method of synthesizing the urethane (meth)acrylate-based macromonomer is not particularly limited, and examples thereof include the following methods (i) to (iii).

(i) A method in which (b) polyisocyanate and (c) hydroxyl group-containing (meth)acrylate are made to react with each other, and, subsequently, (a) polyol is made to react.

(ii) A method in which (a) polyol, (b) polyisocyanate, and (c) hydroxyl group-containing (meth)acrylate are prepared all together and made to react with one another.

(iii) A method in which (a) polyol and (b) polyisocyanate are made to react with each other, and, subsequently, (c) hydroxyl group-containing (meth)acrylate is made to react.

In the synthesis of urethane (meth)acrylate that is used in the invention, generally, it is preferable to use 0.01 parts by mass to 1 part by mass of a urethanification catalyst, such as copper naphthenate, cobalt naphthenate, zinc naphthenate, dilaurylic acid di-n-butyltin, triethyl amine, 1,4-diazabicyclo[2.2.2]octane, or 1,4-diaza-2-methylbicyclo[2.2.2]octane, with respect to a total amount of 100 parts by mass of reactants. The reaction temperature in the reaction is generally 0 to 90° C., and preferably 10 to 80° C.

The urethane (meth)acrylate-based macromonomer that is preferred from the viewpoint of producing the ultraviolet-curable composition having preferable coating aptitude includes the following (A) and (B).

(A) Reaction products of a polyol compound having a mass average molecular weight of 1000 to 10000, a polyisocyanate compound, and a hydroxyl group-containing (meth)acrylate compound.

(B) Reaction products of a polyol compound, a polyisocyanate compound, and a hydroxyl group-containing (meth)acrylate compound having a mass average molecular weight of 1000 to 10000.

The proportion of the urethane (meth)acrylate-based macromonomer in 100 parts by mass of a composition is preferably 10 parts by mass to 80 parts by mass, more preferably 15 parts by mass to 75 parts by mass, and still more preferably 20 parts by mass to 70 parts by Mass in terms of the glass transition temperature of an intermediate layer being formed and the viscosity of the ultraviolet-curable composition. Meanwhile, the urethane (meth)acrylate-based macromonomer may be used singly or in combination of two or more kinds.

The ultraviolet-curable composition includes urethane (meth)acrylate-based macromonomers and polymerizable monomer components of monofunctional (meth)acrylates, multifunctional (meth)acrylates, and the like. The ultraviolet-curable composition may be used singly or in combination of two or more kinds. The polymerizable monomers include acrylates represented by the following general formula (a) and methacrylates represented by the following general formula (b).

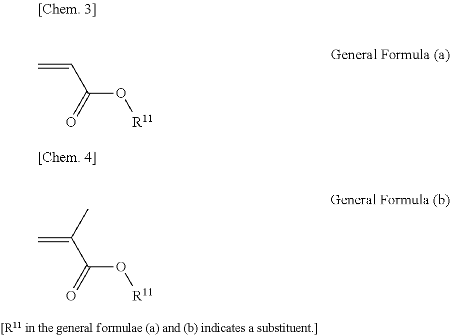

More specifically, examples of the polymerizable monomers that can be used in the invention include the following: examples of the monofunctional (meth)acrylate include (meth)acrylates having a substituent, in which examples of the substituent R¹¹ in the general formulae (a) and (b) include a methyl group, an ethyl group, a propyl group, a butyl group, a sec-butyl group, a tert-butyl group, a pentyl group, a hexyl group, a heptyl group, a 2-ethyl hexyl group, an octyl group, a nonyl group, a dodecyl group, a hexadecyl group, an octadecyl group, a cyclohexyl group, a benzyl group, a methoxy ethyl group, a butoxy ethyl group, a phenoxy ethyl group, a nonyl phenoxy ethyl group, a tetrahydrofurfuryl group, a glycidyl group, a 2-hydroxy ethyl group, a 2-hydroxy propyl group, a 3-chloro-2-hydroxy propyl group, a dimethyl amino ethyl group, a diethyl amino ethyl group, a nonyl phenoxy ethyl tetrahydrofurfuryl group, a caprolactone-modified tetrahydrofurfuryl group, an isobornyl group, a dicyclopentanyl group, a dicyclopentenyl group, or a dicyclopentenyloxy ethyl group, and the like, and, furthermore, includes (meth)acrylic acid.

The preferred substituent R¹¹ includes a butyl group, a pentyl group, a hexyl group, a heptyl group, a 2-ethyl hexyl group, an octyl group, a nonyl group, and a dodecyl group, and the more preferred monomer includes butyl acrylate, hexyl acrylate, 2-ethyl hexyl acrylate, octyl acrylate, nonyl acrylate, and dodecyl methacrylate.

In addition, examples of the multifunctional (meth)acrylate include diacrylates, such as 1,3-butylene glycol, 1,4-butanediol, 1,5-pentanediol, 3-methyl-1,5-pentanediol, 1,6-hexanediol, neopentyl glycol, 1,8-octanediol, 1,9-nonanediol, tricylcodecane methanol, ethylene glycol, polyethylene glycol propylene glycol dipropylene glycol, tripropylene glycol, or polypropylene glycol, di(meth)acrylate of isocyanurate, di(meth)acrylates of diols obtained by adding 4 or more moles of ethylene oxide or propylene oxide to 1 mole of neopentyl glycol, (meth)acrylates of diols obtained by adding 2 moles of ethylene oxide or propylene oxide to 1 mole of bisphenol A, trimethylolpropane tri(meth)acrylate, di- or tri(meth)acrylates of triols obtained by adding 3 or more moles of ethylene oxide or propylene oxide to 1 mole of trimethylolpropane, di(meth)acrylates of diols obtained by adding 4 or more moles of ethylene oxide or propylene oxide to 1 mole of bisphenol A, tris(2-hydroxyethyl)isocyanurate tri(meth)acrylate, tris(2-hydroxyethyl)isocyanurate tri(meth)acrylate, tri(meth)acrylates obtained by adding 3 or more moles of ethylene oxide or propylene oxide to 1 mole of tris(2-hydroxyethyl)isocyanurate, pentaerythritol or tetra(meth)acrylate, tri- or tetra(meth)acrylates obtained by adding 4 or more moles of ethylene oxide or propylene oxide to 1 mole of pentaerythritol, poly(meth)acrylates of dipentaerythritol, poly(meth)acrylates obtained by adding 6 or more moles of ethylene oxide or propylene oxide to 1 mole of dipentaerythritol, caprolactone-modified tris[(meth)acryloxyethyl]isocyanurate, poly(meth)acrylates of alkyl-modified dipentaerythritol, poly(meth)acrylates of caprolactone-modified pentaerythritol, hydroxyl pivalic acid neopentyl glycol diacrylate, caprolactone-modified hydroxyl pivalic acid neopentyl glycol diacrylate, ethylene oxide-modified phosphoric acid (meth)acrylate, ethylene oxide-modified alkylated phosphoric acid (meth)acrylate, and the like.

Preferred examples thereof include di(meth)acrylates of diols obtained by adding 4 or more moles of ethylene oxide or propylene oxide to 1 mole of bisphenol A, di- or tri(meth)acrylates of triols obtained by adding 3 or more moles of ethylene oxide or propylene oxide to 1 mole of trimethylolpropane, tri(meth)acrylates obtained by adding 3 or more moles of ethylene oxide or propylene oxide to 1 mole of tris(2-hydroxyethyl) isocyanurate, tetra(meth)acrylates obtained by adding 4 or more moles of ethylene oxide or propylene oxide to 1 mole of pentaerythritol, and poly(meth)acrylates obtained by adding 6 or more moles of ethylene oxide or propylene oxide to 1 mole of dipentaerythritol, and more preferred examples thereof include di(meth)acrylates of diols obtained by adding 4 or more moles of ethylene oxide or propylene oxide to 1 mole of bisphenol A, di- or tri(meth)acrylates of triols obtained by adding 3 or more moles of ethylene oxide or propylene oxide to 1 mole of trimethylolpropane, and tri- or tetra(meth)acrylates obtained by adding 4 or more moles of ethylene oxide or propylene oxide to 1 mole of pentaerythritol.

In addition, N-vinyl-2-pyrrolidone, acryloylmorpholine, vinyl imidazole, N-vinyl caprolactame, N-vinyl formamide, vinyl acetate, (meth)acrylic acid, (meth)acrylamide, N-hydroxymethyl acrylamide, N-hydroxyethyl acrylamide, and alkyl ether compounds thereof can also be used.

Furthermore, polymerizable oligomers can also be used as the ultraviolet-curable compound. The polymerizable oligomers include polyester (meth)acrylate, polyether (meth)acrylate, epoxy (meth)acrylate, urethane (meth)acrylate, and the like.

The content of the polymerizable compound that is jointly used in the ultraviolet curable composition is preferably 90 parts by mass to 20 parts by mass, more preferably 85 parts by mass to 25 parts by mass, and still more preferably 80 parts by mass to 30 parts by mass with respect to 100 parts by mass of the ultraviolet curable composition.

Generally, a photopolymerization initiator is added to the ultraviolet curable composition. The photopolymerization initiator is not particularly limited as long as an ultraviolet curable compound represented by a polymerizable monomer and/or a polymerizable oligomer being used can be cured. Molecule cleavable or hydrogen abstraction photopolymerization initiators are preferred as the photopolymerization initiator in the invention.

The photopolymerization initiator is preferably benzoin isobutyl ether, 2,4-diethyl thioxanthone, 2-isopropyl thioxanthone, 2-chlorothioxanthone, benzil, 2,2-dimethoxy-2-phenylacetephenone, 2,4,6-trimethyl benzoyl diphenyl phosphine oxide, 2-benzyl-2-dimethylamino-1-(4-morpholinophenyl)-butane-1-one, bis(2,6-dimethoxy benzoyl)-2,4,4-trimethyl pentyl phosphine oxide, or the like. Furthermore, as a molecule cleavable photopolymerization initiator other than the above, 1-hydroxy cyclohexyl phenyl ketone, benzoyl ethyl ether, benzyl dimethyl ketal, 2-hydroxy-2-methyl-1-phenyl-propane-1-one, 1-(4-isopropylphenyl)-2-hydroxy-2-methypropane-1-one, 2-methyl-4′-(methylthio)-2-morpholinopropiophenone, or the like may be jointly used, and, furthermore, benzophenone, 4-phenyl benzophenone, isophthalophenone, 4-benzoyl-4′-methyl-diphenyl sulfide, and the like, which are the hydrogen abstraction photopolymerization initiator, may also be jointly used.

The photopolymerization initiator is preferably 2,4-diethyl thioxanthone, 2-isopropyl thioxanthone, 2-chlorothioxanthone, 2,2-dimethoxy-2-phenylacetephenone, 2,4,6-trimethyl benzoyl diphenyl phosphine oxide, 1-hydroxy cyclohexyl phenyl ketone, 2-methyl-4′-(methylthio)-2-morpholinopropiophenone, 4-phenylbenzophenone, and more preferably 2-isopropyl thioxanthone, 2-chlorothioxanthone, 2,2-dimethoxy-2-phenylacetephenone, 2,4,6-trimethyl benzoyl diphenyl phosphine oxide, 1-hydroxy cyclohexyl phenyl ketone, 2-methyl-4′-(methylthio)-2-morpholinopropiophenone, or 4-phenylbenzophenone.

In addition, it is also possible to jointly use amines that do not cause an addition polymerization reaction with the above polymerizable components, for example, triethylamine, methyl diethanolamine, triethanolamine, p-diethylaminoacetophenone, p-di methylaminoacetophenone, ethyl p-dimethylamino benzoate, amyl p-dimethylamino benzoate, N,N-dimethyl benzyl amine, 4,4′-bis(diethylamino)benzophenone, and the like, as a sensitizer with respect to the photopolymerization initiator. Naturally, it is preferable to select and use the photopolymerization initiator or sensitizer that is excellent in terms of the solubility in the curable components, and does not impair ultraviolet permeability.

In addition, it is also possible to further mix in a thermal polymerization inhibitor, an oxidation inhibitor represented by a hindered phenol, hindered amine, phosphide, and the like, a plasticizer, a silane coupling agent represented by epoxy silane, mercapto silane, (meth)acryl silane, and the like, and the like as additional additives, according to necessity, in the ultraviolet curable composition to improve a variety of characteristics. When the additives are used, it is preferable to differentiate additives that are excellent in terms of the solubility in curable components and additives that do not impair ultraviolet transmission.

The amounts of the photopolymerization initiator, the sensitizer and the variety of additives used in the ultraviolet curable composition can be appropriately set.

The irradiance level of ultraviolet rays irradiated for curing of the adhesive composition is preferably more than 200 mJ/cm², and more preferably in a range of 200 mJ/cm² to 2000 mJ/cm². Examples of UV lamps that can be used for curing include a metal halide lamp M02-L31 (manufactured by Eye Graphics Co., Ltd., cold mirror-attached, a lamp output of 120 W/cm), a 4.2 inch-spiral lamp, manufactured by Xenon Corporation, and the like. The distance between the lamp surface and a sample surface during irradiation of ultraviolet rays is preferably set appropriately.

In order to move a medium on which the ultraviolet curable composition is coated to an UV irradiating location (for example, moving from a spin table to an UV irradiation table), it is desirable to hold a substrate at the outer circumferential portion or inner circumferential portion of the medium, raise and move the medium. When the medium is supported from the top by a method of absorption or the like and raised, since the ultraviolet curable composition is not cured, there is a possibility that the medium is deformed or air bubbles are generated in the adhesive composition such that the film thickness variation or defects of the adhesive composition may be caused. In a case in which the substrate is held at the outer circumferential portion and moved, it is preferable to clean the supporting member on a regular basis. There are cases in which uncured ultraviolet curable composition is shaken off and attached to the outer circumferential edge portion during spin, and the uncured ultraviolet curable composition is attached to the supporting member. When the medium is repetitively moved by the same supporting member, there is a possibility that the uncured ultraviolet curable composition may be attached to the medium from the supporting member, and defects may be caused.

In addition, in the UV irradiation location (for example, on the UV irradiation table), one portion or a plurality of portions of the inner circumferential portion, outer circumferential portion, intermediate circumferential portion, and the like of the substrate (medium) can be supported as portions at which the medium is supported. The entire surface may be uniformly supported by a plate-shaped supporting member. In a case in which a plurality of portions is supported, the supporting heights of the respective members can be changed. This is a case in which the outer circumferential portion is also supported and suppressed from hanging so that warpage after curing is suppressed in a case in which, for example, only the inner circumference is supported, the outer circumferential portion of the medium which is not supported hangs down due to its own weight, and the medium is cured in a hung shape, thereby causing warpage of the medium after curing, and an effect of adjusting the medium shape after curing by adjusting the heights of the respective supporting members can be expected.

The ultraviolet curable composition can have high transmittance even after curing. According to the ultraviolet curable composition, it is possible to form an adhesive composition having a transmittance of, for example 100% to 80% as a value which is measured by the method as described in Examples as described below.

The thickness of the adhesive layer is preferably in a range of 50 μm or less, more preferably in a range of 1 μm to 45 μm, and still more preferably in a range of 5 μm to 40 μm from the viewpoint of satisfying both optical characteristics and adhesion force.

<Patterned Optically Anisotropic Layer>

The patterned optically anisotropic layer in the invention is a patterned optically anisotropic layer including the first phase difference areas and the second phase difference areas in which at least one of the inner surface retarded axis directions and the inner surface retardations are mutually different, in which the first and second phase difference areas are alternately disposed in the surface. An example is an optically anisotropic layer in which the first and second phase difference areas have a Re of approximately λ/4 respectively, and the inner surface retarded axes cross orthogonally with respect to each other. A variety of methods can be used to form such an optically anisotropic layer, and, in the invention, the optically anisotropic layer is preferably formed by fixing an orientation state of a composition including a liquid crystalline compound having a polymerizable group. The liquid crystalline compound may be a rod-shaped liquid crystalline compound or a discotic liquid crystalline compound. In addition, the liquid crystalline compound may be a thermotropic liquid crystal or a lyotropic liquid crystal. In the invention, the optically anisotropic layer is preferably formed by polymerizing and fixing a discotic liquid crystal having a polymerizable group in a vertically oriented state.

[Discotic Liquid Crystalline Compound Having a Polymerizable Group]

A discotic liquid crystal that can be used as a main raw material of the optically anisotropic layer of the invention is preferably a compound having a polymerizable group as described above.

The discotic liquid crystal is preferably a compound represented by the following general formula (I).

D(L-H-Q)ₙ General formula (1)

In the formula, D indicates a disc-shaped core, L indicates a divalent coupling group, H indicates a divalent aromatic ring or a hetero ring, Q indicates a polymerizable group, and n indicates an integer of 3 to 12.

The disc-shaped core (D) is preferably a benzene ring, a naphthalene ring, a triphenylene ring, an anthraquinone ring, a pyridine ring, a pyrimidine ring, and a triazine ring, and particularly preferably a benzene ring, a triphenylene ring, a pyridine ring, a pyrimidine ring, and a triazine ring.

L is preferably a divalent coupling group selected from a group consisting of *-O—CO—, *-CO—O—, *-CH═CH—, *-C≡C—, and combinations thereof, and particularly preferably a divalent coupling group including at least one or more of any of *-CH═CH— and *-C≡C—. Here, * represents a location at which is bonded to D in the general formula (I).

H is preferably a benzene ring and a naphthalene ring, and particularly preferably a benzene ring as an aromatic ring, and is preferably a pyridine ring and a pyrimidine ring, and particularly preferably a pyridine ring as a hetero ring. H is particularly preferably an aromatic ring.

The polymerization reaction of the polymerizable group Q is preferably addition polymerization (including open-ring polymerization) or condensation polymerization. In other words, the polymerizable group is preferably a functional group that is available for an addition polymerization reaction or a condensation polymerization reaction. Among them, a (meth)acrylate group and an epoxy group are preferred.

The discotic liquid crystal represented by the general formula (I) is particularly preferably a discotic liquid crystal represented by the following general formula (II) or (III).

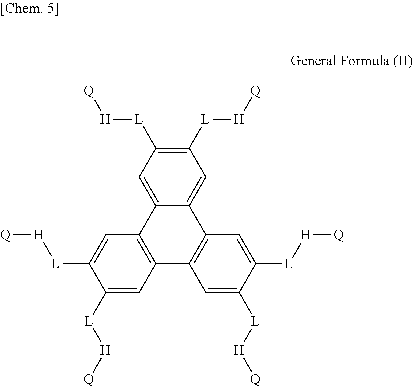

In the formula, L, H, and Q are the same as L, H, and Q in the general formula (I), and have the same preferred ranges.

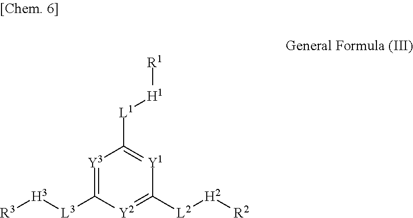

In the formula, Y¹, Y², and Y³ are the same as Y¹¹, Y¹², and Y¹³ in a general formula (IV) as described below, and have the same preferred ranges. In addition, L¹, L², L³, H¹, H², H³, R¹, R², and R³ in the general formula (IV) are also the same as L¹, L², L³, H¹, H², H³, R¹, R², and R³, and have the same preferred ranges.

As described below, since a discotic liquid crystal having a plurality of aromatic rings in the molecules as represented by the general formulae (I), (II), (III), and (IV) causes an intermolecular π-π interaction with an onium salt, such as a pyridinium compound, an imidazolium compound, or the like which is used as an orientation controlling agent, vertical orientation can be realized. Particularly, in a case in which, for example, L is a divalent coupling group including at least one or more of any of *-CH═CH— and —C≡C— in the general formula (II), and in a case in which rings of a plurality of aromatic rings and hetero rings are bonded to each other through single bonds in the general formula (III), the free rotation of the bonds by the coupling group is strongly restricted so that the linearity of the molecules is held, and therefore the crystallinity is improved, a stronger intermolecular π-π interaction is caused, and stable vertical orientation can be realized.

The discotic liquid crystal is preferably a compound represented by the following general formula (IV).

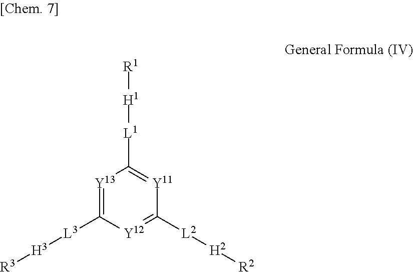

In the formula, Y¹¹, Y¹², and Y¹³ respectively represent methane or a nitrogen atom that may be substituted; L¹, L², and L³ respectively represent a single bond or divalent coupling group; H¹, H², and H³ respectively represent a group of the general formula (I-A) or (I-B); and R¹, R², and R³ respectively represent the following general formula (I-R).

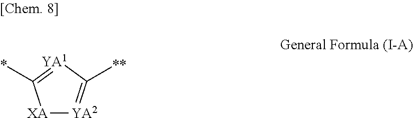

In the general formula (I-A), YA¹ and YA² respectively represent methane or a nitrogen atom; XA represents an oxygen atom, a sulfur atom, methane, or imino; * represents locations that bond with L¹ to L³ sides in the general formula (IV); and ** represents locations that bond with R¹ to R³ sides in the general formula (IV).

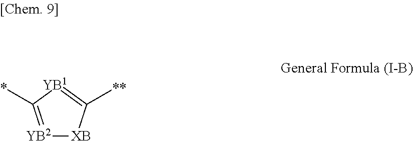

In the general formula (I-B), YB¹ and YB² respectively represent methane or a nitrogen atom; XB represents an oxygen atom, a sulfur atom, methane, or imino; * represents locations that bond with L¹ to L³ sides in the general formula (IV); and ** represents locations that bond with R¹ to R³ sides in the general formula (IV).

*-(-L²¹-Q²)ₙ₁-L²²-L²²-L²³-Q¹ General formula (I-R)

In the general formula (I-R), * represents locations that bond with H¹ to H³ sides in the general formula (IV); L²¹ represents a single bond or divalent coupling group; Q² represents a divalent group (cyclic group) having at least one kind of cyclic structure; nl represents an integer of 0 to 4; L²² represents **-O—, **-O—CO—, **-CO—O—, **-O—CO—O—, **-S—, **-NH—, **-SO₂—, **-CH₂—, **-CH═CH— or **-C≡C—; L²³ represents —O—, —S—, —C(═O)—, —SO₂—, —NH—, —CH2-, —CH═CH— and —C≡C— and a divalent coupling group selected from a group composed of combinations thereof; and Q¹ represents a polymerizable group or a hydrogen atom.

Reference can be made to Paragraphs [0013] to [0077] of JP2010-244038 for the preferred ranges of the respective symbols of the 3-substituted benzene-based discotic liquid crystalline compound represented by the formula (IV) and specific examples of the compound represented by the formula (IV). However, the discotic liquid crystalline compound that can be used in the invention is not limited to the 3-substituted benzene-based discotic liquid crystalline compound of the formula (IV).

Triphenylene compounds include the compounds as described in paragraphs [0062] to [160] of JP2007-108732, but the invention is not limited thereto.

Since the discotic liquid crystal represented by the general formula (IV) has a plurality of aromatic rings in the molecules, the discotic liquid crystal causes a strong intermolecular π-π interaction with a pyridinium compound or an imidazolium compound as described below, and the tilt angle in the vicinity of the surface of an oriented film of the discotic liquid crystal is increased. Particularly, since the discotic liquid crystal represented by the general formula (IV) has a plurality of aromatic rings coupled by single bonds, and thus has a highly linear molecular structure for which the degree of rotation freedom of the molecules is restricted, the discotic liquid crystal cause a stronger intermolecular π-π interaction with a pyridinium compound or an imidazolium compound, and the tilt angle in the vicinity of the surface of an oriented film of the discotic liquid crystal is increased.

In the invention, the discotic liquid crystal is preferably vertically oriented. Further, in the specification, the “vertical orientation” indicates that the disc surface of the discotic liquid crystal and the layer surface are vertical to each other. In the specification, the vertical orientation does not require the disc surface of the discotic liquid crystal and the layer surface to be strictly vertical to each other, and means that the inclination angle formed with the horizontal surface is 70 degrees or more. The inclination angle is preferably 85 degrees to 90 degrees, more preferably 87 degrees to 90 degrees, still more preferably 88 degrees to 90 degrees, and most preferably 89 degrees to 90 degrees.

Meanwhile, additives are preferably added to the composition to promote the vertical orientation of the liquid crystal, and examples of the additives include the compounds as described in [0055] to [0063] in JP2009-223001A.

Meanwhile, it is difficult to directly and accurately measure the tilt angle (an angle formed by physical symmetry axes with respect to the interface of the optically anisotropic layer in the liquid crystalline compound will be referred to as the tilt angle) θ1 on one surface of the optically anisotropic layer and the tilt angle θ2 on the other surface in the optically anisotropic layer in which the liquid crystalline compound is oriented. Therefore, in the specification, θ1 and θ2 are computed by the following method. The present method does not accurately express the actual orientation state of the invention, but is effective as a measure that expresses the relative relationship of a part of optical characteristics of the phase difference plate.

In the method, in order to ease the computation, the following two factors are assumed and used as the tilt angles in two interfaces of the optically anisotropic layer.

1. The optically anisotropic layer is assumed to be a multilayered body constituted by layers including the liquid crystalline compound. Furthermore, the minimum unit of the layer that composes the multilayered body (the tilt angle of the liquid crystalline compound are assumed to be the same in the layers) is optically assumed as an axis.

2. The tilt angles of the respective layers are assumed to monotonously change in a linear function manner along the thickness direction of the optically anisotropic layer.

The specific computation method is as follows:

(1) In the surface at which the tilt angles of the respective layers monotonously change in a linear function manner along the thickness direction of the optically anisotropic layer, the incident angle of measurement light with respect to the optically anisotropic layer changes, and retardation values are measured at three or more measurement angles. In order to simplify measurement and computation, it is preferable to set the normal direction with respect to the optically anisotropic layer to 0°, and measure retardation values at three measurement angles of −40°, 0°, +40°. The measurement can be carried out using a KOBRA-21ADH and a KOBRA-WR (manufactured by Oji Scientific Instruments), a transmission ellipsometer AEP-100 (manufactured by Shimadzu Corporation), M150 and M520 (manufactured by Jasco Corporation), and ABR10A (manufactured by Uniopt Corporation, Ltd.).

(2) In the above model, the refractive index of each layer for normal light is represented by no; the refractive index for abnormal light is represented by ne (ne is the same throughout all the layers, and no is also the same throughout all the layers), and the overall thickness of the multilayered body is represented by d. Furthermore, with an assumption that the tilt direction in each layer and the monoaxial optical axis direction thereof are the same, fitting is carried out using the tilt angle θ1 in one surface of the optically anisotropic layer and the tilt angle θ2 in the other surface as variables so that the computation of the angle dependence of the retardation value of the optically anisotropic layer coincides with a measured value, and θ1 and θ2 are computed.

Here, well-known values, such as values in publications and values in catalogs, can be used as no and ne. In a case in which the values are unknown, the values can be measured using an Abbe refractometer. The thickness of the optically anisotropic layer can be measured using an optical interference thickness gauge, a photograph of the cross section taken using a scanning electronic microscope, or the like.

The rod-shaped compound that can be preferably used in the invention includes azomethines, azoxys, cyano biphenyls, cyano phenyl esters, benzoic acid esters, cyclohexane carboxylic acid phenyl esters, cyano phenyl cyclohexanes, cyano-substituted phenyl pyrimidines, alkoxy-substituted phenyl pyrimidines, phenyl dioxanes, tolans, and alkenyl cyclohexyl benzonitriles. Meanwhile, the rod-shaped liquid crystalline compound also includes a metal complex. In addition, it is also possible to use a liquid crystalline polymer including the rod-shaped liquid crystalline compound in the repetitive unit. In other words, the rod-shaped liquid crystalline compound may be bonded with a (liquid crystalline) polymer.

In addition, the rod-shaped liquid crystalline compound is described in Chapters 4, 7, and 11 of The Chemistry of Liquid Crystals (1994), which is the Quarterly Review of Chemistry Vol. 22 by the Chemical Society of Japan, and Chapter 3 of the Handbook of Liquid Crystal Devices, the 142^{nd} Committee of Japan Society for the Promotion of Science.

In addition, as the rod-shaped liquid crystalline compound, it is possible to use a variety of commercially available rod-shaped liquid crystals, mixtures of rod-shaped liquid crystals, liquid crystalline compositions including rod-shaped liquid crystals, and compounds selected from the compounds as described in the respective publications and specifications of, for example, Makromol. Chem., Vol. 190, page 2255 (1989), Advanced Materials Vol. 5, page 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905, JP 1989-272551 (JP-H1-272551), JP 1994-16616 (JP-H6-16616), 1995-110469 (JP-H7-110469), JP 1999-80081 (JP-H11-80081), JP1999-513019 (JP-H11-513019), JP2001-64627, and the like.

The double reflection of the rod-shaped liquid crystalline compound that is used in the invention is preferably in a range of 0.001 to 0.7.

The rod-shaped liquid crystalline compound preferably has a polymerizable group in order to fix the orientation state. The polymerizable group is preferably an unsaturated polymerizable group or an epoxy group, more preferably an unsaturated polymerizable group, and most preferably an ethylenic unsaturated polymerizable group.

A low molecular rod-shaped liquid crystalline compound is preferably a compound represented by the following general formula (X).

Q¹-L¹-Cy¹-L²-(Cy²-L³)ₙ-Cy³-L⁴-Q² General formula (X)

In the formula, Q¹ and Q² represent a polymerizable group respectively, L¹ and L⁴ represent a divalent coupling group respectively, L² and L³ represent a single-bonded or divalent coupling group respectively, Cy¹, Cy², and Cy³ represent a divalent cyclic group, and n represents 0, 1 or 2.

[Onium Salt Compound (an Orientation Controlling Agent for the Oriented Film)]

In the invention, an onium salt is preferably added in order to realize the vertical orientation of the discotic liquid crystal having a polymerizable group as described above. The onium salt is eccentrically present at the oriented film interface, and has an action of increasing the tilt angle in the vicinity of the oriented film interface of liquid crystal molecules.

The onium salt is preferably a compound represented by the following general formula (1).

Z-(Y-L-)ₙCy⁺.X⁻ General Formula (1)

In the formula, Cy is an onium group of a 5 or 6-membered ring, L, Y, Z, and X are the same as L²³, L²⁴, Y²², Y²³, Z²¹, and X in the general formulae (2a) and (2b) as described below, and also have the same preferred ranges, n represent an integer of 2 or more.

The onium group of a 5 or 6-membered ring (Cy) is preferably a pyrazolium ring, an imidazolium ring, a triazolium ring, a tetrazolium ring, a pyridinium ring, a pyrazinium ring, a pyrimidinium ring, or a triazinium ring, and particularly preferably an imidazolium ring or a pyridinium ring.

The onium group of a 5 or 6-membered ring (Cy) preferably has a group having an affinity to the oriented film material. Furthermore, the onium salt compound preferably has an affinity to the oriented film material which is high at a temperature T₁° C., but, conversely, degraded at a temperature T₂° C. In an actual temperature range (room temperature to approximately 150° C.), hydrogen bonds can be in a bonding state or a state in which the bonds are lost, and therefore use of an affinity due to hydrogen bonds is preferred. However, the affinity is not limited to the above example.

For example, in an aspect in which a polyvinyl alcohol is used as an oriented film material, the onium salt compound preferably has a hydrogen-bonding group in order to form a hydrogen bond with the hydroxyl group of the polyvinyl alcohol. Examples of theoretical analysis of the hydrogen bond include a report of H. Uneyama and K. Morokuma, Journal of American Chemical Society, Vol. 99. Pages 1316 to 1332, 1977. Examples of specific hydrogen bond forms include the forms as described in FIG. 17, page 98, Intermolecular Force and Surface Force, J. N. Israerachiviri, translated by Kondo Tamotsu and Oshima Hiroyuki, McGraw-Hill (1991). Examples of the specific hydrogen bonds include the hydrogen bond as described in G. R. Desiraju, Angewante Chemistry International Edition English, Vol. 34, page 2311, 1995.

In addition to the effect of the affinity, the onium group of a 5 or 6-membered ring having the hydrogen-bonding group causes more oriented film interfaces to be eccentrically present on the surface due to the hydrogen bond with the polyvinyl alcohol, and promotes a function of supplying orthogonal orientation with respect to polyvinyl alcohol main chains. Preferable hydrogen-bonding groups include an amino group, a carbonamide group, a sulfonamide group, an acid amide group, an ureido group, a carbamoyl group, a carboxylic group, a sulfo group, a nitrogen-containing hetero ring group (for example, an imidazolyl group, a benzimidazolyl group, a pyrazolyl group, a pyridyl group, a 1,3,5-triazyl group, a pyrimidyl group, a pyridazyl group, a quinolyl group, a benzimidazolyl group, a benzthiazolyl group, a succinicimide group, a phthalimide group, a maleimide group, a uracil group, a thiouracil group, a barbituric acid group, a hydantoin group, a maleic hydrazide group, an isatin group, an uramyl, and the like). More preferable hydrogen-bonding group includes an amino group and a pyrizyl group.

For example, it is also preferable that an atom having a hydrogen-bonding group be contained in the onium ring of a 5 or 6-membered ring as the nitrogen atom in an imidazolium ring.

n is preferably an integer of 2 to 5, more preferably an integer of 3 or 4, and particularly preferably 3. A plurality of L and Y may be mutually the same or different. In a case in which n is 3 or more, since the onium salt represented by the general formula (1) has three or more 5 or 6-membered rings, a strong intermolecular π-π interaction works with the discotic liquid crystal, and therefore it is possible to realize a vertical orientation of the discotic liquid crystal, particularly, on a polyvinyl alcohol oriented film, an orthogonal vertical orientation with respect to the polyvinyl alcohol main chain.

The onium salt represented by the general formula (1) is particularly preferably a pyridinium compound represented by the following general formula (2a) or an imidazolium compound represented by the following general formula (2b).

The compound represented by the general formulae (2a) and (2b) is added in order mainly to control the orientation in the oriented film interface of the discotic liquid crystal represented by the general formulae (I) to (IV), and has an action of increasing the tilt angle in the vicinity of the oriented film interface of the molecules in the discotic liquid crystal.

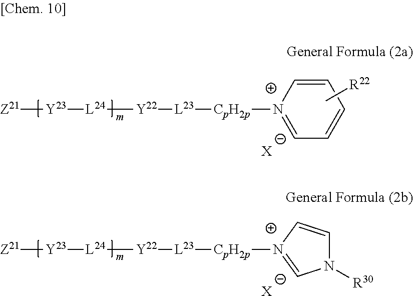

In the formula, L²³ and L²⁴ represent a divalent coupling group respectively.

L²³ is preferably a single bond, —O—, —O—CO—, —CO—O—, —C≡C—, —CH═CH—, —CH═N—, —N═CH—, —N═N—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—, and AL is an alkylene group having 1 to 10 carbon atoms. L²³ is preferably a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—, more preferably a single bond or —O—, and most preferably —O—.

L²⁴ is preferably a single bond, —O—, —O—CO—, —CO—O—, —C≡C—, —CH═CH—, —CH═N—, —N═CH—, —N═N—, and more preferably —O—CO— or —CO—O—. When m is 2 or more, a plurality of L²⁴ is more preferably —O—CO— and —CO—O— alternately.

R²² is a hydrogen atom, an unsubstituted amino group, or a substituted amino group having 1 to 20 carbon atoms.

In a case in which R²² is a dialkyl-substituted amino group, a nitrogen-containing hetero ring may be formed by mutually binding two alkyl groups. The nitrogen-containing hetero ring formed at this time is preferably a 5-membered ring or a 6-membered ring. R²³ is more preferably a hydrogen atom, an unsubstituted amino group, or a dialkyl substituted amino group having 2 to 12 carbon atoms, and still more preferably a hydrogen atom, an unsubstituted amino group, or a dialkyl substituted amino group having 2 to 8 carbon atoms. In a case in which R²³ is an unsubstituted amino group and a substituted amino group, four positions of the pyridinium ring are preferably substituted.

X is an anion.

X is preferably a monovalent anion. Examples of the anion include a halide ion (a fluorine ion, a chlorine ion, a bromine ion, and an iodine ion) and a sulfonic acid ion (for example, a methane sulfonate ion, a p-toluene sulfonate ion, and a benzene sulfonate ion).

Y²² and Y²³ are respectively a divalent coupling group having a 5 or 6-membered ring as the partial structure.

The 5 or 6-membered ring may have a substituent. Preferably, at least one of Y²² and Y²³ is a divalent coupling group having a 5 or 6-membered ring that has a substituent as the partial structure. Y²² and Y²³ are preferably a divalent coupling group having a 6-membered ring that may have a substituent as the partial structure respectively. The 6-membered ring includes an aliphatic ring, an aromatic ring (benzene ring), and a hetero ring. Examples of the 6-membered aliphatic ring include a cyclohexane ring, a cyclohexene ring, and a cyclohexadiene ring. Examples of the 6-membered hetero ring include a pyran ring, a dioxane ring, a dithiane ring, a thiine ring, a pyridine ring, a piperidine ring, an oxazine ring, a morpholine ring, a thiazine ring, a pyridazine ring, a pyrimidine ring, a pyrazine ring, a piperazine ring and a triazine ring. The 6-membered ring may have other 6-membered or 5-membered rings condensed therein.

Examples of the substituent include a halogen atom, cyano, an alkyl group having 1 to 12 carbon atoms, and an alkoxy group having 1 to 12 carbon atoms. The alkyl group and the alkoxy group may be substituted with an acyl group having 2 to 12 carbon atoms or an axyloxy group having 2 to 12 carbon atoms. The substituent is preferably an alkyl group having 1 to 12 carbon atoms (more preferably 1 to 6 carbon atoms, and still more preferably 1 to 3 carbon atoms). The number of the substituent may be 2 or more. For example, in a case in which Y²² and Y²³ are a phenylene group, the alkyl group and the alkoxy group may be substituted with 1 to 4 alkyl groups having 1 to 12 carbon atoms (more preferably 1 to 6 carbon atoms, and still more preferably 1 to 3 carbon atoms).

Meanwhile, m is 1 or 2, and preferably 2. When m is 2, a plurality of Y²³ and L²⁴ may be mutually the same or different.

Z²¹ is a monovalent group selected from a group consisting of a halogen-substituted phenyl, a nitro-substituted phenyl, a cyano-substituted phenyl, a phenyl substituted with an alkyl group having 1 to 10 carbon atoms, a phenyl substituted with an alkoxy group having 2 to 10 carbon atoms, an alkyl group having 1 to 12 carbon atoms, an alkynyl group having 2 to 20 carbon atoms, an alkoxy group having 1 to 12 carbon atoms, an alkoxycarbonyl group having 2 to 13 carbon atoms, an aryloxycarbonyl group having 7 to 26 carbon atoms, and an arylcarbonyl group having 7 to 26 carbon atoms.

In a case in which m is 2, Z²′ is preferably cyano, an alkyl group having 1 to 10 carbon atoms, or an alkoxy group having 1 to 10 carbon atoms, and still more preferably an alkoxy group having 4 to 10 carbon atoms.

In a case in which m is 1, Z²¹ is preferably an alkyl group having 7 to 12 carbon atoms, an alkoxy group having 7 to 12 carbon atoms, an acyl-substituted alkyl group having 7 to 12 carbon atoms, an acyl-substituted alkoxy group having 7 to 12 carbon atoms, an acyloxy-substituted alkyl group having 7 to 12 carbon atoms, and an acyloxy-substituted alkoxy group having 7 to 12 carbon atoms.

An acyl group is represented by —CO—R, an acyloxy group is represented by —O—CO—R, and R is an aliphatic group (an alkyl group, a substituted alkyl group, an alkenyl group, a substituted alkenyl group, an alkynyl group, or a substituted alkynyl group) or an aromatic group (an aryl group, or a substituted aryl group). R is preferably an aliphatic group, and more preferably an alkyl group or an alkenyl group.

p is an integer of 1 to 10. p is particularly preferably 1 or 2. CₚH₂ₚ refers to a chain-shaped alkylene group that may have a branched structure. CₚH₂ₚ is preferably a straight-chain alkylene group (—(CH₂)ₙ—).

In the formula (2b), R³⁰ is an alkyl group having 1 to 12 (more preferably 1 to 6, and still more preferably 1 to 3) hydrogen atoms or carbon atoms.

Among the compounds represented by the formula (2a) or (2b), the compounds represented by the formula (2a′) or (2b′) are preferred.

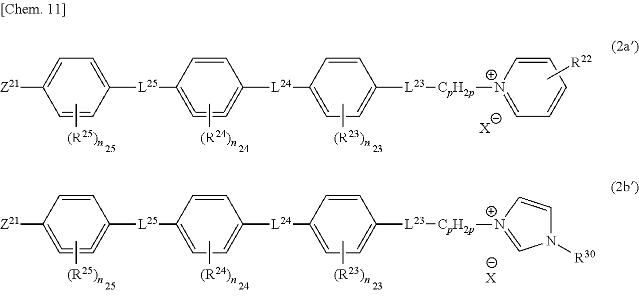

In the formulae (2a′) and (2b′), the same reference numerals as in the formula (2) have the same meaning and the same preferred ranges. L²⁵ and L²⁴ have the same meaning and the same preferred ranges. L²⁴ and L²⁵ are preferably —O—CO— or —CO—O—, and it is preferable that L²⁵ be —O—CO— and L²⁴ be —CO—O—.

R²³, R²⁴, and R²⁵ are respectively an alkyl group having 1 to 12 (more preferably 1 to 6, and still more preferably 1 to 3) carbon atoms. n₂₃ represents 0 to 4, n₂₄ represents 1 to 4, and n₂₅ represents 0 to 4. It is preferable that n₂₃ and n₂₅ be 0, and n₂₄ be 1 to 4 (more preferably 1 to 3).

R³⁰ is preferably an alkyl group having 1 to 12 (more preferably 1 to 6, and still more preferably 1 to 3) carbon atoms.

Specific examples of the compound represented by the general formula (2) include the compounds as described in [0058] to [0061] in JP2006-113500A.

Hereinafter, specific examples of the compound represented by the general formula (2′) are shown. However, in the following formulae, anions (X⁻) are not shown.

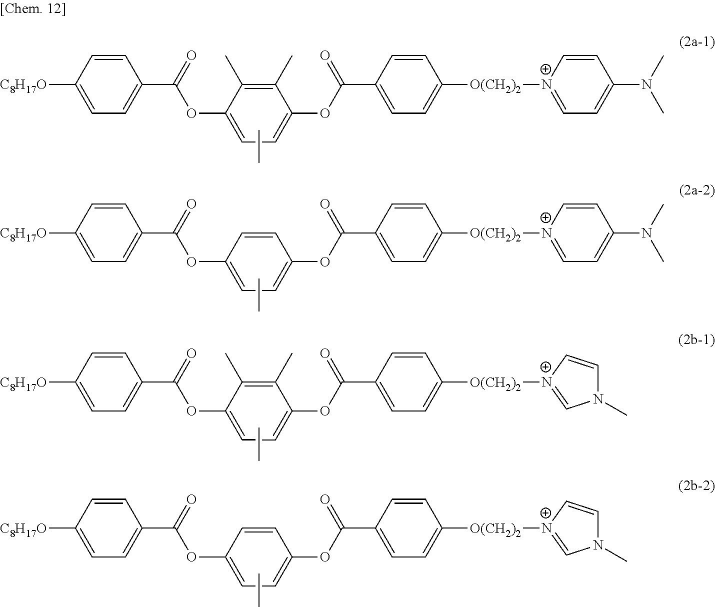

The compounds of the formulae (2a) and (2b) can be manufactured by an ordinary method. For example, the pyridinium derivative of the formula (2a) is obtained by ordinarily alkylating (Menschutkin reaction) a pyridine ring.

The added amount of the onium salt does not exceed 5% by mass with respect to the liquid crystalline compound, and is preferably approximately 0.1% by mass to 2% by mass.

The onium salt represented by the general formulae (2a) and (2b) is eccentrically present on the surface of a hydrophilic polyvinyl alcohol oriented film since the pyridinium group or the imidalinium group is hydrophilic. Particularly, when the pyridinium group is further substituted with an amino group, which is a substituent of the acceptor of a hydrogen atom (in the general formulae (2a) and (2a′), R²² is an unsubstituted amino group or a substituted amino group having 1 to 20 carbon atoms), an intermolecular hydrogen bond is generated between the onium salt and a polyvinyl alcohol, the onium salt is eccentrically present on the oriented film surface more densely, and the pyridinium derivative is oriented in an orthogonal direction to the main chain of the polyvinyl alcohol due to the effect of the hydrogen bond, and therefore orthogonal orientation of the liquid crystals with respect to a rubbing direction is promoted. Since the pyridinium derivative has a plurality of aromatic rings in the molecules, a strong intermolecular π-π interaction is caused between the pyridinium derivative and the liquid crystal, particularly, the discotic liquid crystal, and orthogonal orientation is induced in the vicinity of the oriented film surface of the discotic liquid crystal. Particularly, when a hydrophobic aromatic ring is bonded to a hydrophilic pyridinium group as represented by the general formula (2a′), the hydrophobic effect also results in an effect of inducing vertical orientation.

Furthermore, when the onium salt represented by the general formulae (2a) and (2b) is jointly used, parallel orientation in which the retarded axes of the liquid crystal are oriented in parallel with the rubbing direction can be promoted by heating the onium salt to higher than a certain temperature. This is because the hydrogen bonds with the polyvinyl alcohol are broken due to thermal energy by the heating, the onium salt is uniformly dispersed in the oriented film, the density on the surface of the oriented film is lowered, and the liquid crystal is oriented by the restraining force of a rubbing oriented film.

[Air Interface Orientation Controlling Agent]

The air interface orientation controlling agent is added in order to control the orientation in the air interface of the liquid crystal, mainly the discotic liquid crystal represented by the general formula (I), and has an action of increasing the tilt angle in the vicinity of the air interface of the molecules of the liquid crystal.

The air interface orientation controlling agent that can be used in the invention include the compounds as described in JP2004-333852A, JP2004-333861A, JP2005-134884A, JP2005-179636A, JP2005-181977, and the like, and is particularly preferably a fluoro aliphatic group-containing copolymer including in the side chains a fluoro aliphatic group and one or more kinds of hydrophilic groups selected from a group consisting of a carboxylic group (—COOH), a sulfo group (—SO₃H), phosphonoxy {—OP(═O)(OH)₂}, and salts thereof all of which are described in JP2005-179636A and JP2005-181977.

The added amount of the air interface orientation controlling agent does not exceed 2% by mass with respect to the liquid crystalline compound, and is preferably approximately 0.1% by mass to 1% by mass.

The fluoro aliphatic group-containing copolymer can increase the eccentricity to the air interface due to the hydrophobic effect of the fluoro aliphatic group, supply a low surface energy field to the air interface side, and increase the tilt angle of the liquid crystal, particularly, the discotic liquid crystal. Furthermore, when the fluoro aliphatic group-containing copolymer has a copolymer component including one or more kinds of hydrophilic groups selected from a group consisting of a carboxylic group (—COOH), a sulfo group (—SO₃H), phosphonoxy {—OP(═O)(OH)₂}, and salts thereof at the side chain, it is possible to realize vertical orientation of the liquid crystal compound due to charge repulsion between anions thereof and the π electrons in the liquid crystal.

[Solvent]

The composition that is used to form the optically anisotropic layer is preferably prepared as a coating fluid. A solvent that is used to prepare the coating fluid is preferably an organic solvent. Examples of the organic solvent include amides (for example, N,N-dimethylformamide), sulfoxides (for example, dimethylsulfoxide), heterocyclic compounds (for example, pyridine), hydrocarbons (for example, benzene and hexane), alkyl halides (for example, chloroform and dichloromethane), esters (for example, methyl acetate and butyl acetate), ketones (for example, acetone and methyl ethyl ketone), and ethers (for example, tetrahydrofuran and 1,2-dimethoxyethane). Alkyl halides and ketones are preferred. Two or more kinds of the organic solvents may be jointly used.

[Polymerization Initiator]

A composition (for example, the coating fluid) containing the liquid crystalline compound having the polarizable group is made into an orientation state in which a desired liquid crystalline phase is shown, and then the orientation state is fixed through ultraviolet irradiation. The orientation state is preferably fixed by a polymerization reaction of a reactive group that is introduced to the liquid crystalline compound. The orientation state is preferably fixed by a photopolymerization reaction caused by ultraviolet irradiation. The photopolymerization may be any of radical polymerization and cation polymerization. Examples of the radical photopolymerization initiator include α-carbonyl compounds (U.S. Pat. No. 2,367,661B and U.S. Pat. No. 2,367,670B), acyloin ethers (U.S. Pat. No. 2,448,828B), α-hydrocarbon substituted aromatic acyloin compounds (U.S. Pat. No. 2,722,512B), polynuclear quinone compounds (U.S. Pat. No. 3,046,127B and U.S. Pat. No. 2,951,758B), combination of triarylimidazole dimer and p-aminophenyl ketone (U.S. Pat. No. 3,549,367B), acridine and phenazine compounds (JP1985-105667A (JP-S60-105667A) and U.S. Pat. No. 4,239,850B) and oxadiazole compounds (U.S. Pat. No. 4,212,970B). Examples of the cation photopolymerization initiator that can be proposed include organic sulfonium salt-based, iodonium salt-based, and phosphonium salt-based photopolymerization initiators, organic sulfonium salt-based photopolymerization initiators are preferred, and triphenyl sulfonium salt is particularly preferred. As the counterion of the compounds, hexafluoroantimonite, hexafluorophosphate, and the like are preferably used.

The used amount of the photopolymerization initiator is preferably 0.01% by mass to 20% by mass, and more preferably 0.5% by mass to 5% by mass of the solid content of the coating fluid.

[Sensitizer]

In addition, a sensitizer as well as the polymerization initiator may also be used to increase the sensitivity. Examples of the sensitizer include n-butylamine, triethylamine, tri-n-butylphosphine, thioxanthone, and the like. Plural kinds of the photopolymerization initiators may be combined, and the used amount of the photopolymerization initiator is preferably 0.01% by mass to 20% by mass, and more preferably 0.5% by mass to 5% by mass of the solid content of the coating fluid. Ultraviolet rays are preferably used for light irradiation for polymerization of the liquid crystalline compound.

[Other Additives]

Separately from the polymerizable liquid crystal compound, the composition may also contain a non-liquid crystalline polymerizable monomer. The polymerizable monomer is preferably a compound having a vinyl group, a vinlyoxy group, an acryloyl group, or a methacryloyl group. Meanwhile, when a multifunctional monomer having 2 or more polymerizable reactive functional groups, for example, ethylene oxide-modified trimethylolpropane acrylate is used, the durability is improved, which is preferable. Since the non-liquid crystalline polymerizable monomer is a non-liquid crystalline component, the added amount thereof does not exceed 40% by mass with respect to the liquid crystalline compound, and is preferably approximately 0% by mass to 20% by mass.

The thickness of the optically anisotropic layer manufactured in the above manner is not particularly limited, but is preferably 0.1 μm to 10 μm, and more preferably 0.5 μm to 5 μm.

<Oriented Film>

The oriented film that can realize a patterned optically anisotropic layer may be formed between the optically anisotropic layer and the transport supporting body. Any of a light oriented film and a rubbing oriented film may be used as the oriented film, but the rubbing oriented film is preferably used.

The “rubbing oriented film” that can be used in the invention refers to films that are subjected to a rubbing treatment so as to provide an orientation-regulating function of liquid crystal molecules. The rubbing oriented film has an orientation axis that regulates the orientation of the liquid crystal molecules, and the liquid crystal molecules are oriented in accordance with the orientation axis. The material of the oriented film, an acid generating agent, a liquid crystal, and an orientation controlling agent are selected so that the liquid crystal molecules are oriented in parallel with the retarded axis of the liquid crystal with respect to the rubbing direction at the ultraviolet-irradiated portions of the oriented film, and the retarded axis of the liquid crystal molecules are orthogonally oriented with respect to the rubbing direction at the non-irradiated portions.

Generally, the rubbing oriented film has a polymer as a main component. Polymer materials for the oriented film are described in many publications, and can be obtained from many commercially available products. The polymer material that is used in the invention is preferably polyvinyl alcohol, polyimide, or derivatives thereof, and particularly preferably modified or unmodified polyvinyl alcohol. The polyvinyl alcohol has a variety of saponification degrees. In the invention, a polyvinyl alcohol having a saponification degree of approximately 85 to 99 is preferably used. A commercially available product may be used, and, for example, “PVA 103,” “PVA 203,” (manufactured by Kuraray Co., Ltd.) and the like are PVAs having the above saponification degree. With regard to the rubbing oriented film, the modified polyvinyl alcohols as described in line 24 on page 43 through line 8 on page 49 in WO01/88574A1 and paragraphs [0071] to [0095] of JP3907735B can be referenced. The thickness of the rubbing oriented film is preferably 0.01 μm to 10 μm, and more preferably 0.01 μm to 1 μm.

Generally, the rubbing treatment can be carried out by rubbing the surface of a film having a polymer as a main component with paper or a fabric in a constant direction several times. An ordinary method of the rubbing treatment is described in, for example, “Liquid Crystal Handbook,” (Maruzen Company, Limited, Oct. 30, 2000).

As a method for changing the rubbing density, it is possible to use the method as described in “Liquid Crystal Handbook,” (Maruzen Company, Limited, Oct. 30, 2000). The rubbing density (L) is quantified by the following formula (A).

L=Nl(1+2πrn/60v) Formula (A)

In the formula (A), N represents a rubbing cycle, l represents the contact length of the rubbing roller, r represents the radius of the roller, n represents the rotation speed (rpm) of the roller, and v is the stage moving speed (per second).

An increase in the rubbing density requires an increase in the rubbing cycle, an increase in the contact length of the rubbing roller, an increase in the radius of the roller, an increase in the rotation speed of the roller, and a decrease of the stage moving speed, and a decrease in the rubbing density requires the opposite operations.

The rubbing density and the pretilt angle have a relationship in which an increase in the rubbing density results in a decrease in the pretilt angle, and a decrease in the rubbing density results in an increase in the pretilt angle.

In order to adhere to a long polarization film having an absorption axis in the longitudinal direction, it is preferable to form an oriented film on a supporting body composed of a long polymer film, and carry out the rubbing treatment continuously in a 45° direction with respect to the longitudinal direction, thereby forming a rubbing oriented film.

If possible (for example, in a case in which light irradiation for decomposing a photo acid generating agent and light irradiation for developing a light orientation function can be separately carried out), a light oriented film may be used.

In addition, the oriented film may contain at least one kind of photo acid generating agent. The photo acid generating agent refers to a compound that is decomposed by light irradiation of ultraviolet rays or the like so as to generate an acidic compound. When the photo acid generating agent is decomposed by light irradiation so as to generate an acidic compound, a change in the orientation controlling function of the oriented film is caused. The change in the orientation controlling function as mentioned herein may be specified as a change in the orientation controlling function of the oriented film only, a change in the orientation controlling function that is achieved by the oriented film and additives included in the composition for the optically anisotropic layer disposed thereon, and the like, or a change specified as a combination of the above two.

There are cases in which the discotic liquid crystal is made into an orthogonally vertical orientation state when the onium salt is added. When an acid generated by the decomposition and the onium salt exchange the anions, a parallel vertical orientation state may be formed by degrading the eccentricity of the onium salt on the oriented film surface, and degrading the orthogonally vertical orientation effect. In addition, for example, in a case in which the oriented film is a polyvinyl alcohol-based oriented film, the eccentricity of the onium salt at the oriented film interface may be consequently changed by decomposing the ester portion using the generated acid.

The optically anisotropic layer can be formed by a variety of methods in which the oriented film is used, and the method is not particularly limited.

A first aspect is a method in which a plurality of actions that affect the orientation control of the discotic liquid crystal is used, and then some actions are lost due to external stimuli (a thermal treatment and the like), thereby making predetermined orientation control actions dominant. For example, the discotic liquid crystal is made into a predetermined orientation state using a combined action of an orientation control function of an oriented film and an orientation control function of an orientation controlling agent added to the liquid crystalline composition, the orientation state is fixed so as to form a phase difference area, then, one of the actions (for example, the action of the orientation controlling agent) is lost due to external stimuli (a thermal treatment and the like), the other orientation control action (the action of the oriented film) is made to be dominant so as to realize another orientation state, and the orientation state is fixed so as to form the other phase difference area. For example, since the pyridinium group or the imidazolium group in the pyridinium compound represented by the general formula (2a) or the imidazolium compound represented by the general formula (2b) is hydrophilic, the group is eccentrically present on the surface of the hydrophilic polyvinyl alcohol oriented film. Particularly, when the pyridinium group is further substituted with an amino group, which is a substituent of the acceptor of a hydrogen atom (in the general formulae (2a) and (2a′), R²² is an unsubstituted amino group or a substituted amino group having 1 to 20 carbon atoms), an intermolecular hydrogen bond is generated between the onium salt and a polyvinyl alcohol, the onium salt is eccentrically present on the oriented film surface more densely, and the pyridinium derivative is oriented in an orthogonal direction to the main chain of the polyvinyl alcohol due to the effect of the hydrogen bond, and therefore the liquid crystals are promoted to be orthogonally oriented with respect to a rubbing direction. Since the pyridinium derivative has a plurality of aromatic rings in the molecules, a strong intermolecular π-π interaction is caused between the pyridinium derivative and the liquid crystal, particularly, the discotic liquid crystal, and an orthogonal orientation is induced in the vicinity of the oriented film surface of the discotic liquid crystal. Particularly, when a hydrophobic aromatic ring is bonded to a hydrophilic pyridinium group as represented by the general formula (2a′), the hydrophobic effect also results in an effect of inducing vertical orientation. However, when the optically anisotropic layer is heated to higher than a certain temperature, the hydrogen bond is broken, the density of the pyridinium compound and the like on the surface of the oriented film is lowered, and the actions are lost. As a result, the liquid crystal is oriented by the restraining force of the rubbing oriented film, and the liquid crystal is made into a parallel orientation state. The above method is described in detail in JP2010-141345A, and the contents are cited from the specification thereof.

A second aspect is an aspect in which the pattern oriented film is used. In this aspect, pattern oriented films having mutually different orientation controlling functions are formed, a liquid crystal composition is disposed on the pattern oriented films, and the liquid crystal is oriented. The orientation of the liquid crystal is regulated by the respective orientation controlling functions of the pattern orientation films, and mutually different orientation states are achieved. When the respective orientation states are fixed, the patterns of the first and second phase difference areas are formed according to the patterns of the oriented films. The pattern oriented films can be formed by a printing method, mask-rubbing with respect to a rubbing oriented film, mask exposure with respect to a photo oriented film, or the like. In addition, it is also possible to form a pattern oriented film by uniformly forming an oriented film, and separately printing additives that affect the orientation controlling function (for example, the onium salt and the like) in a predetermined pattern. A method in which a printing method is used is preferred since a large facility is not required, and manufacturing is easy. The above method is described in detail in JP2010-173077A, and the contents are cited from the specification thereof.

In addition, the first and second aspects may be jointly used. An example is that a photo acid generating agent is added to the oriented film. In this example, the photo acid generating agent is added to the oriented film, the photo acid generating agent is decomposed by pattern exposure so as to form an area in which an acidic compound is generated and an area in which an acidic compound is not generated. In portions in which light is not irradiated, the photo acid generation agent is seldom decomposed, the interaction among the oriented film material, the liquid crystal, and an orientation controlling agent that is added according to desire dominates the orientation state, and the liquid crystal is oriented in a direction in which the retarded axis crosses orthogonally with the rubbing direction. When light is irradiated to the oriented film, and an acidic compound is generated, the interaction conversely loses the dominancy, the rubbing direction of the rubbing oriented film dominates the orientation state, and the liquid crystal is oriented in parallel in which the retarded axis is in parallel with the rubbing direction. A water-soluble compound is preferably used as the photo acid generating agent that is used for the oriented film. Examples of available photo acid generating agents include the compounds as described in Prog. Polym. Sci., Vol 23, page 1485 (1998). A pyridinium salt, an iodonium salt, and a sulfonium salt are particularly preferably used as the photo acid generating agent. The above method is described in detail in JP2010-289360, and the contents are cited from the specification thereof.

Furthermore, as a third aspect, there is a method in which discotic liquid crystals having polymerizable groups for which the polymerization properties are mutually different (for example, an oxetanyl group and a polymerizable ethylenic unsaturated group) are used. In this aspect, the discotic liquid crystals are made into a predetermined orientation state, and then light irradiation and the like are carried out under conditions in which a polymerization reaction of only one polymerizable group proceeds, thereby forming a pre-optically anisotropic layer. Next, mask exposure is carried out under conditions in which the other polymerizable group can be polymerized (for example, in the presence of a polymerization initiator that initiates the polymerization of the other polymerizable group). The orientation state of the exposed portions is completely fixed, and one phase difference area having a predetermined Re is formed. In unexposed areas, a reaction of one reactive group proceeds, but the other reactive group remains unreacted. Therefore, when the liquid crystal is heated to a temperature exceeding an isotropic phase temperature at which a reaction of the other reactive group can proceed, the unexposed area is fixed in an isotropic phase state, that is, Re becomes 0 nm.

<Linear Polarization Layer>

An ordinary polarization film can be used as the linear polarization layer that can be used in the invention. For example, it is possible to use a polarization film composed of a polyvinyl alcohol film and the like which are dyed using iodine or a dichromatic colorant. In addition, it is also possible to use a linear polarization layer formed by coating a composition containing a dichromatic liquid crystalline colorant, making the composition into a predetermined orientation state, and fixing the orientation state.

<Surface Layer>

The 3D image display apparatus of the invention has a surface layer on the outermost surface on the observation side. The surface layer preferably includes an anti-reflection layer for preventing reflected glare of external light, and includes the anti-reflection layer preferably as the outermost surface layer. In addition, the surface layer may be composed of the anti-reflection layer only.

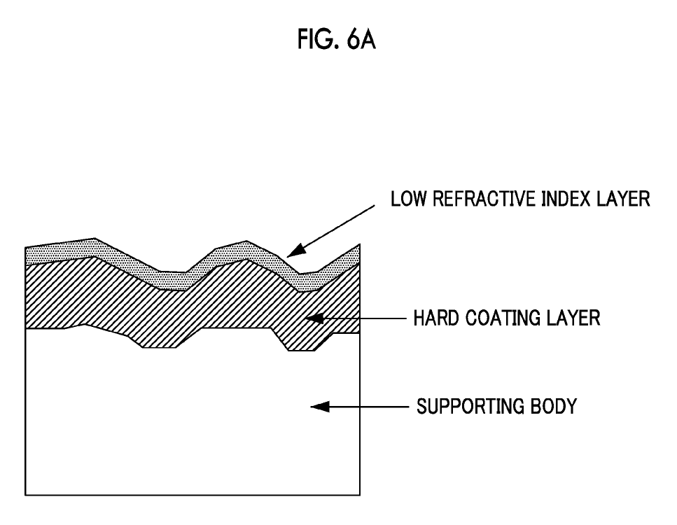

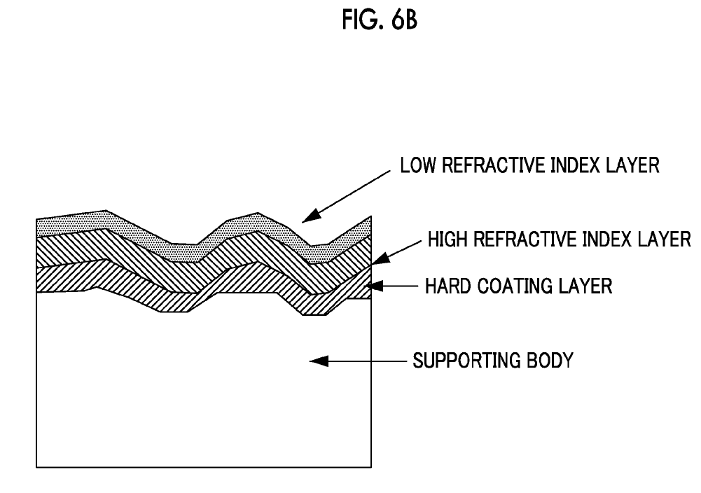

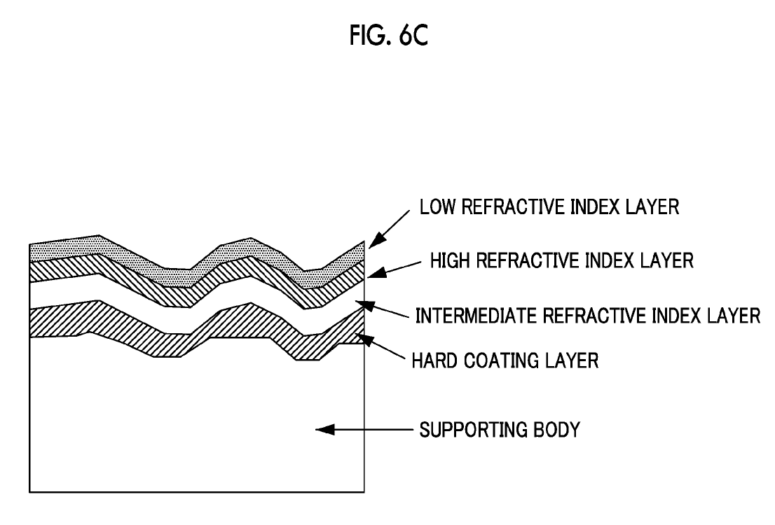

Examples of the surface layer include an aspect in which a low refractive layer, a hard coating layer, and a transparent supporting layer are laminated sequentially as shown in FIG. 6A, an aspect in which a low refractive index layer, a high refractive index layer, a hard coating layer, and a transparent supporting body are laminated sequentially as shown in FIG. 6B, an aspect in which a low refractive index layer, a high refractive index layer, an intermediate refractive index layer, a hard coating layer, and a transparent supporting body are laminated sequentially, and the like, as shown in FIG. 6C. The transport supporting body is a film, and may be used as the supporting body of the patterned optically anisotropic layer.

[Anti-Reflection Layer]

In the invention, an anti-reflection layer in which a light scattering layer and a low refractive index layer are laminated in this order or an anti-reflection layer in which an intermediate reflective index layer, a high refractive index layer, and a low refractive index layer are laminated in this order on a transparent supporting body is preferably used. This is because such an anti-reflection layer can effectively prevent occurrence of flicker due to external light reflection particularly in a case in which 3D images are displayed.

Hereinafter, preferred examples thereof will be described.

A preferred example of an anti-reflection layer provided with a light scattering layer and a low refractive index layer on a transparent supporting body will be described.

Matt particles are dispersed in the light scattering layer, and the refractive index of the material of the portions of the light scattering layer in which matt particles are not dispersed is preferably in a range of 1.50 to 2.00, and the refractive index of the low refractive index layer is preferably in a range of 1.35 to 1.49. The light scattering layer has both antidazzling properties and hard coating properties, and may be a single layer or plural layers that are constituted by, for example, two layers to four layers.

When the anti-reflection layer is made to have a protrusion and recess shape on the surface, and designed to have a central line average roughness Ra of 0.08 μm to 0.40 μm, a 10-point average roughness Rz of 10 times or less Ra, an average peak distance Sm of 1 μm to 100 μm, a standard deviation of the protrusion height from the deepest portion of the recess portion of 0.5 μm or less, a standard deviation of the average peak distance Sm from the central line as a criterion of 20 μm or less, a proportion of 0 degree to 5 degrees-inclined surfaces of 10% or less, sufficient antidazzling properties and visually uniform matt feeling are achieved, which is preferable.

In addition, when the tone of reflected light under a C light source has a ratio 0.5 to 0.99 of the minimum value to the maximum value of the reflectance in a range of a* value −2 to 2, b* value −3 to 3, 380 nm to 780 nm, the tone of the reflected light becomes natural, which is preferable. In addition, when the b* value of transmitted light under a C light source is made to be 0 to 3, a yellow tone in white display is reduced when the anti-reflection layer is applied to a display apparatus, which is preferable.

In addition, when the standard deviation of the brightness distribution when a 120 μm×40 μm grid is inserted between a surface light source and the anti-reflection layer, and the brightness distribution is measured on the film, is 20 or less, variation is reduced when the anti-reflection layer is applied to a high-definition panel, which is preferable.

When the anti-reflection layer has a mirror reflectance of 2.5% or less, a transmission of 90% or more, and a 60-degree glossiness of 70% or less as the optical characteristics, the anti-reflection layer can suppress reflection of external light, and the visibility is improved, which is preferable. Particularly, the mirror reflectance is more preferably 1% or less, and most preferably 0.5% or less. When the haze is set to 20% to 50%, a ratio of the inner haze to the total haze is set to 0.3 to 1, a decrease of the haze value after formation of a low refractive index layer from the haze value of up to the light scattering layer is set to 15% or less, the transmitted image definition at a comb width of 0.5 mm is set to 20% to 50%, and the transmittance ratio of vertically transmitted light to the transmittance in a direction 2 degree inclined from the vertical is set to 1.5 to 5.0, prevention of glare on a high-definition LCD panel and reduction of unclearness of letters and the like are achieved, which is preferred.

The refractive index of the low refractive index layer is 1.20 to 1.55, and preferably 1.30 to 1.55. Furthermore, the low refractive index layer preferably satisfies the following formula (IX) in terms of a decrease in the reflectance.

(mλ/4)×0.7<n1d1<(mλ/4)×1.3 Formula (IX)

In the formula, m is a positive odd number, n1 is the refractive index of the low refractive index layer, and d1 is the film thickness (nm) of the low refractive index layer. In addition, λ is the wavelength and a value in a range of 500 nm to 550 nm.

The low refractive index layer preferably includes a fluorine-containing polymer as a low refractive index binder. The fluorine-containing polymer is preferably a fluorine-containing polymer that is crosslinked by heat or ionizing radiation having a dynamic friction coefficient of 0.03 to 0.20, a contact angle with respect to water of 90° to 120°, and a slip drop angle of pure water of 70° or less. When the anti-reflection film of the invention is mounted in an image display apparatus, a seal or memo becomes easily peeled off after attachment as the separation force with a commercially available adhesive tape is decreased, which is preferable, and the separation force is preferably 500 gf or less, more preferably 300 gf or less, and most preferably 100 gf or less. In addition, damage is not easily caused as the surface hardness measured using a micro hardness meter is increased, and the surface hardness is preferably 0.3 GPa or more, and more preferably 0.5 GPa or more.

The fluorine-containing polymer that is used for the low refractive index layer includes fluorine-containing copolymers having a fluorine-containing monomer unit and a constituent unit for supplying crosslinking reactivity as the constituents as well as hydrolyzed substances and dehydrated condensates of perfluoroalkyl group-containing silane compounds (for example, (heptadecafluoro-1,1,2,2-tetrahydrodecyl)triethoxy silane).

Specific examples of the fluorine-based monomer include fluoroolefins (for example, fluoroethylene, vinylidene fluoride, tetrafluoroethylene, perfluorooctyl ethylene, hexafluoropropylene, perfluoro-2,2-dimethyl-1,3-dioxol, and the like), partially or fully fluorinated alkyl ester derivatives of (meth)acrylic acids (for example, BISCOAT 6FM (manufactured by Osaka Organic Chemical Industry, Ltd.), M-2020 (manufactured by Daikin Industries, Ltd.), and the like), fully or partially fluorinated vinyl ethers, and the like. The fluorine-based monomer is preferably a perfluoroolefin, and particularly preferably hexafluoropropylene from the viewpoint of the refractive index, solubility, transparency, availability, and the like.

The constituent for supplying the crosslinking reactivity includes constituents obtained by polymerization of monomers having self-crosslinking functional groups in the molecules in advance, such as glycidyl (meth)acrylate, and glycidyl vinyl ether, constituents obtained by polymerization of monomers having a carboxylic group, a hydroxyl group, an amino group, a sulfo group, or the like (for example, (meth)acrylic acid, methylol (meth)acrylate, hydroxyl alkyl (meth)acrylate, allyl acrylate, hydroxyethyl vinyl ether, hydroxylbutyl vinyl ether, maleic acid, crotonic acid, and the like), constituents having a crosslinking reactive group, such as a (meth)acryloyl group, introduced to the constituent by a polymer reaction (for example, a crosslinking reactive group can be introduced by a method in which acrylic acid chloride is made to act with respect to a hydroxyl group).

In addition, it is also possible to appropriately copolymerize monomers containing no fluorine atom in addition to the fluorine-containing monomer unit and the constituent for supplying the crosslinking reactivity from the viewpoint of the solubility in a solvent, the transparency of a membrane, and the like. The monomer unit that can be jointly used is not particularly limited, and examples thereof include olefins (ethylene, propylene, isoprene, vinyl chloride, vinylidene chloride, and the like), acrylic acid esters (methyl acrylate, ethyl acrylate, 2-ethylhexyl acrylate), methacrylic acid esters (methyl methacrylate, ethyl methacrylate, butyl methacrylate, ethylene glycol dimethacrylate, and the like), styrene derivatives (styrene, divinyl benzene, vinyl toluene, α-methyl styrene, and the like), vinyl esters (methyl vinyl ether, ethyl vinyl ether, cyclohexyl vinyl ether, and the like), acrylamides (N-tert-butyl acrylamide, N-cyclohexyl acrylamide, and the like), methacrylamides, acrylonitirile derivatives, and the like.

With respect to the above polymers, a curing agent may be appropriately jointly used as described in JP-1998-25388A (JP-H10-25388A) and JP1998-147739 (JP-H10-147739).

The low refractive index layer may include micro voids. When micro voids are formed, the refractive index of the layer is approximated to the refractive index of air, 1.00. The micro voids are formed among fine particles and/or in fine particles included in the layer. The low refractive index layer including micro voids can be formed by coating a dispersion fluid of organic fine particles, inorganic fine particles, or combined particles thereof on the surface and drying the dispersion fluid. The material and method that are used to form the low refractive index layer of this example are described in detail in JP1997-222502A (JP-H9-222502A), JP1997-288201A (JP-H9-288201A), and JP1999-6902A (JP-H11-6902A), which can be referenced in manufacturing the optically anisotropic layer having a low refractive index.

The light scattering layer is formed to contribute light scattering properties by surface scattering and/or internal scattering and hard coating properties for improving the abrasion properties of the film to the film. Therefore, the light scattering layer is formed by including a binder for supplying hard coating properties, matt particles for supplying light scattering properties, and inorganic fillers for an increase in the refractive index, prevention of crosslinking contract, and an increase in the strength.

The film thickness of the light scattering layer is preferably 1 μm to 10 μm, and more preferably 1.2 μm to 6 μm from the viewpoint of supplying hard coating properties and suppressing occurrence of curling and deterioration of brittleness.

The binder for the scattering layer is preferably a polymer having a saturated hydrocarbon chain or a polyether chain as the main chain, and more preferably a polymer having a saturated hydrocarbon chain as the main chain. In addition, the binder polymer preferably has a crosslinking structure. The binder polymer having a saturated hydrocarbon chain as the main chain is preferably a polymer of an ethylenic unsaturated monomer. The binder polymer having a saturated hydrocarbon chain as the main chain and a crosslinking structure is preferably a (co)polymer of a monomer having two or more ethylenic unsaturated groups. In order to increase the refractive index of the binder polymer, it is also possible to select a binder polymer including in the structure at least one kind of atom selected from a halogen atom, a sulfur atom, a phosphorous atom, and a nitrogen atom in addition to an aromatic ring or fluorine.

Monomers having two or more ethylenic unsaturated groups include esters of a multivalent alcohol and (meth)acrylic acid (for example, ethylene glycol di(meth)acrylate, butanediol di(meth)acrylate, hexanediol di(meth)acrylate, 1,4-cyclohexane diacrylate, and pentaerythritol tetra(meth)acrylate, pentaerythritol (meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), modified ethylene oxides thereof, vinyl benzene and derivatives thereof (for example, 1,4-divinyl benzene, 4-vinyl benzoic acid-2-acryloyl ethyl ester, and 1,4-divinyl cyclohexanone), acrylamides (for example, methylene bisacrylamide) and methacrylamides. Two or more kinds of the monomers may be jointly used.

Specific examples of the high refractive index monomer include bis(4-methacryloyl thiophenyl)sulfides, vinyl naphthalene, vinylphenyl sulfides, 4-methacryloxy phenyl-4′-methoxy phenylthio ether, and the like. Two or more kinds of the monomers may also be jointly used.

The monomer having the ethylenic unsaturated group can be polymerized by irradiation of ionizing radiation or heating in the presence of a photoradical initiator or a thermoradical initiator.

Therefore, the anti-reflection layer can be formed by preparing a coating fluid containing a monomer having the ethylenic unsaturated group, a photoradical initiator or a thermoradical initiator, matt particles, and inorganic fillers, and curing the coating fluid on a transparent supporting body by a polymerization reaction caused by ionizing radiation or heat after the coating. Well-known initiators can be used as the photoradical initiator and the like.

The polymer having a polyether as the main chain is preferably a ring-opened polymer of a multifunctional epoxy compound. The ring-opened polymerization of the multifunctional epoxy compound can be carried out by irradiation of ionizing radiation or heating in the presence of a photo acid generating agent or a thermo acid generating agent.

Therefore, the anti-reflection layer can be formed by preparing a coating fluid containing a multifunctional epoxy compound, a photo acid generating agent or a thermo acid generating agent, matt particles, and inorganic fillers, and curing the coating fluid on a transparent supporting body by a polymerization reaction caused by ionizing radiation or heat after the coating.

A crosslinking structure may be introduced to the binder polymer by introducing a crosslinking functional group to a polymer using a monomer having a crosslinking functional group instead of or together with the monomer having two or more ethylenic unsaturated groups, and causing a reaction of the crosslinking functional group.

Examples of the crosslinking functional group include an isocyanate group, an epoxy group, an aziridine group, an oxaxoline group, an aldehyde group, a carbonyl group, a hydrazine group, a carboxylic group, a methylol group, and an active methylene group. A metal alkoxide, such as vinylsulfonates, acid anhydride, cyano acrylate derivatives, melamine, etherified methylol, ester and urethane, and tetramethoxysilane, can also be used as the monomer for introducing the crosslinking structure. A functional group showing crosslinking properties as a result of a decomposition reaction, such as a block isocyanate group, may be used. That is, the crosslinking functional group in the invention may exhibit reactivity as a result of decomposition even when the crosslinking functional group does not react immediately.

The binder polymer having the crosslinking functional group can form a crosslinking structure by heating after coating.

The light scattering layer contains matt particles that are larger than the filler particles, the average particle diameter of which is 1 μM to 10 μm, and preferably 1.5 μm to 7.0 μm, for example particles of an inorganic compound or resin particles.

Specific examples of the matt particles preferably include silica particles, particles of an inorganic compound, such as TiO₂ particles; and resin particles, such as acryl particles, crosslinking acryl particles, polystyrene particles, crosslinking styrene particles, melamine resin particles, and benzoguanamine resin particles. Among them, crosslinking styrene particles, crosslinking acryl particles, crosslinking acrylic styrene particles, and silica particles are preferred. The shape of the matt particles that can be used is any of a spherical shape or an irregular shape.

In addition, two or more kinds of matt particles having mutually different particle diameters may be jointly used. Antidazzling properties can be supplied by the matt particles having a larger particle diameter, and separate optical characteristics can be supplied by the matt particles having a smaller particle diameter.

Furthermore, the particle size distribution of the matt particles is most preferably monodispersity, and the particle diameters of the respective particles are preferably approximated to each other. For example, in a case in which particles having a particle diameter 20% or more larger than the average particle diameter are regulated as coarse particles, the proportion of the coarse particles is preferably 1% or less of the total particle number, more preferably 0.1% or less, and still more preferably 0.01% or less. After an ordinary synthesis reaction, the matt particles having the above particle size distribution are obtained by classification, and a matt agent having a more preferably distribution can be obtained by increasing the number of classification or intensifying the degree of classification.

The matt particles are contained in the light scattering layer so that the amount of the matt particles in the formed light scattering layer preferably becomes 10 mg/m² to 1000 mg/m², and more preferably 100 mg/m² to 700 mg/m².

The particle size distribution of the matt particles is measured by the Coulter counter method, and the measured distribution is converted to a particle number distribution.

The light scattering layer preferably contains inorganic fillers that are composed of at least one kind of metallic oxide selected from titanium, zirconium, aluminum, indium, zinc, lead, and antimony, and have an average particle diameter of 0.2 μm or less, preferably 0.1 μm or less, and more preferably 0.06 μm or less in order to increase the refractive index of the layer.

In addition, conversely, in order to increase the difference of the refractive index with the matt particles, it is also preferable to use an oxide of silicon in the light scattering layer, in which the matt particles having a high refractive index are used, to maintain the refractive index of the layer at a low level. The preferable particle diameter is the same as for the inorganic fillers.

Specific examples of the inorganic fillers that are used in the light scattering layer include TiO₂, ZrO₂, Al₂O₃, In₂O₃, ZnO, SnO₂, Sb₂O₃, ITO, SiO₂, and the like. TiO₂ and ZrO₂ are particularly preferable in terms of an increase in the refractive index. It is also preferable to carry out a silane coupling treatment or a titanium coupling treatment on the surfaces of the inorganic fillers, and a surface treatment agent having a functional group that can react with a binder is preferably used on the filler surfaces.

The added amount of the inorganic fillers is preferably 10% to 90% of the total mass of the light scattering layer, more preferably 20% to 80%, and particularly preferably 30% to 75%.

Meanwhile, such fillers are not scattered since the particle diameter is sufficiently smaller than the wavelength of light, and a dispersed body having the fillers dispersed in the binder polymer acts as an optically uniform substance.

The bulk refractive index of a mixture of the binder and the inorganic fillers in the light scattering layer is preferably 1.48 to 2.00, and more preferably 1.50 to 1.80. In order to obtain the refractive index in the above ranges, the kinds and amount proportions of the binder and the inorganic fillers may be appropriately selected. How to select the kind and amount proportion can be easily found experimentally in advance.

The light scattering layer contains any of a fluorine-based surfactant and a silicone-based surfactant or both in a coating composition for forming an antidazzling layer particularly in order to secure a surface shape homogeneity by preventing coating variation, drying variation, point defects, and the like. Particularly, the fluorine-based surfactant is preferably used since the fluorine-based surfactant exhibits an effect of improving surface shape troubles, such as the coating variation, drying variation, point defects, and the like of the anti-reflection film of the invention at a smaller added amount. Containing the surfactant is for increasing the productivity by increasing the surface shape homogeneity and providing high-speed coating aptitude.

Next, the anti-reflection layer in which the intermediate refractive index layer, the high refractive index layer, and the low refractive index layer are laminated in this order on the transparent supporting body will be described.

The anti-reflection layer composed of a layer configuration in which at least the intermediate refractive index layer, the high refractive index layer, and the low refractive index layer (outermost layer) are laminated in this order on the transport supporting body is designed so as to have a refractive index that satisfies the following relationship.

The refractive index of the high refractive index layer>the refractive index of the intermediate refractive index layer>the refractive index of the transparent supporting body>the refractive index of the low refractive index layer

In addition, a hard coating layer may be provided between the transparent supporting body and the intermediate refractive index layer. Furthermore, the layer configuration may be composed of an intermediate refractive index hard coating layer, the high refractive index layer, and the low refractive index layer (for example, refer to JP1996-122504A (JP-H8-122504A), JP1996-110401A (JP-H8-110401A), JP1998-300902A (JP-H10-300902A) JP2002-243906A, and JP2000-111706A). In addition, the respective layers may be supplied with other functions, for example, the antifouling low refractive index layer, the antistat high refractive index layer (for example, refer to JP1998-206603A (JP-H10-206603A), JP2002-243906A, and the like), and the like.

The strength of the anti-reflection film is preferably 1 H or more, more preferably 2 H or more, and most preferably 3 H or more in a pencil scratch hardness test according to JIS K5400.

(The High Refractive Index Layer and the Intermediate Refractive Index Layer)

The layer having a high refractive index in the anti-reflection film is composed of a thermosetting film containing at least high-refractive index inorganic compound ultrafine particles having an average particle diameter of 100 nm or less and a matrix binder.

The high-refractive index inorganic compound fine particles include inorganic compounds having a refractive index of 1.65 or more, and more preferably inorganic compounds having a refractive index of 1.9 or more. Examples thereof include oxides of Ti, Zn, Sb, Sn, Zr, Ce, Ta, La, In, and the like, and composite oxides including the above metal atoms, and the like.

Such ultrafine particles can be made by treating particle surfaces using a surface treatment agent (for example, a silane coupling agent and the like: JP1999-295503A (JP-H11-295503A), JP1999-153703A (JP-H11-153703A), and JP2000-9908A, an anionic compound or an organic metal coupling agent: JP2001-310432A), forming a core shell structure in which high-refractive index particles are used as the core (JP2001-166104A and JP2001-310432A), jointly using a specific dispersion agent (for example JP2009-153703A, U.S. Pat. No. 6,210,858B, JP2002-2776069A, and the like), and the like.

Materials that form a matrix include well-known thermoplastic resins, curable resin membranes, and the like in the related art.

Furthermore, one kind of composition selected from multifunctional compound-containing compositions having at least two radical polymerizable and/or cationic polymerizable groups and compositions having an organic metallic compound that contains a hydrolyzing group and partial condensates thereof is preferred. Examples thereof include compositions as described in JP2000-47004A, JP2001-315242A, JP2001-31871A, JP2001-296401, and the like. In addition, a colloidal metallic oxide obtained from a hydrolysis condensate of a metal alkoxide and a curable film obtained from a metal alkoxide composition are also preferred. Examples are described in JP2001-293818A and the like.

The refractive index of the high refractive index layer is generally 1.70 to 2.20. The thickness of the high refractive index layer is preferably 5 nm to 10 μm, and more preferably 10 nm to 11-1 μM.

The refractive index of the intermediate refractive index layer is adjusted to become a value between the refractive index of the low refractive index layer and the refractive index of the high refractive index layer. The refractive index of the intermediate refractive index layer is preferably 1.50 to 1.70. In addition, the thickness is preferably 5 nm to 10 μm, and more preferably 10 nm to 1 μm.

The low refractive index layer is sequentially laminated on the high refractive index layer. The refractive index of the low refractive index layer is 1.20 to 1.55, and preferably 1.30 to 1.55.

The outermost layer preferably has abrasion resistance and antifouling properties. As a measure to significantly improve the abrasion resistance, supply of skidding properties to the surface is effective, and well-known measures of the related art in which a thin film layer is obtained by introduction of silicone, introduction of fluorine, and the like can be applied.

The refractive index of a fluorine-containing compound is preferably 1.35 to 1.50, and more preferably 1.36 to 1.47. In addition, the compound preferably includes a crosslinking or polymerizable functional group including a fluorine atom in a range of 35% by mass to 80% by mass.

Examples thereof include the compounds as described in paragraphs [0018] to [0026] of JP1997-222503A (JP-H9-222503), paragraphs [0019] to [0030] of JP1999-38202A (JP-H11-38202A), paragraphs [0027] to [0028] of JP2001-40284A, JP2000-284102A, and the like. The silicone compound is a compound having a polysiloxane structure, and preferably a compound containing a curable functional group or a polymerizable functional group in the polymer chains so as to have a bridged structure in the film. Examples thereof include reactive silicon (for example, SILAPLANE manufactured by Chisso Corporation), polysiloxane containing silanol groups at both ends (JP1999-258403A (JP-H11-258403A) and the like), and the like.

The crosslinking or polymerization reaction of a fluorine and/or siloxane-containing polymers having a crosslinking or polymerizable group is preferably carried out by light irradiation or heating at the same time or after coating of a coating composition for forming the outermost layer that contains a polymerization initiator, a sensitizer, and the like.

In addition, a sol-gel cured film that is cured by a condensation reaction of an organic metallic compound, such as a silane coupling agent, and a specific fluorine-containing hydrocarbon group-containing silane coupling agent in the co-presence of a catalyst is also preferred.

Examples thereof include polyfluoroalkyl group-containing silane compounds and partially hydrolyzed condensates thereof (the compounds as described in JP1983-142958A (JP-S58-142958A), JP1983-147483A (JP-S58-147483A), JP1983-147484A (JP-S58-147484, JP1997-157582A (JP-H9-157582A), and JP1999-106704A (JP-H11-106704)), silane compounds containing a poly“perfluoroalkyl ether” group which is a fluorine-containing long chain group (the compounds as described in JP2000-117902A, JP2001-48590A, and JP2002-53804A), and the like.

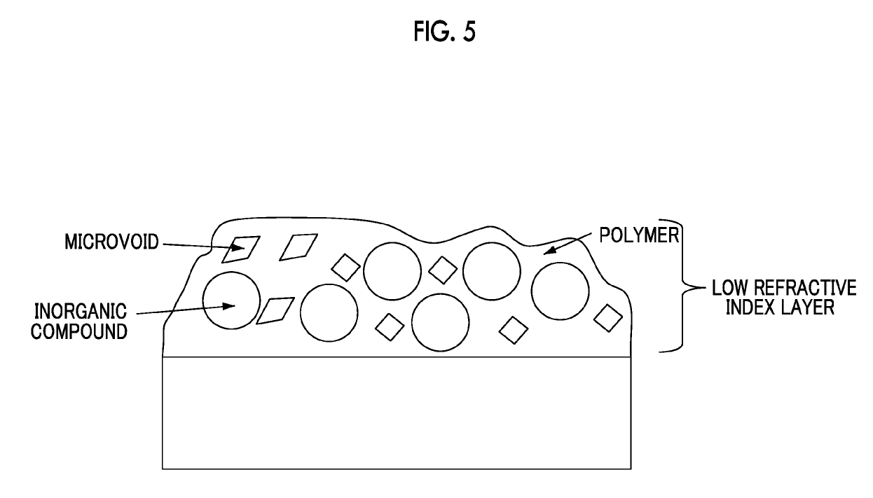

The low refractive index layer can contain a packing material (for example, silicon dioxide (silica), fluorine-containing particles (low refractive index inorganic compounds (inorganic fine particles) having a primary particle average diameter of 1 nm to 150 nm of magnesium fluoride, calcium fluoride, barium fluoride), alkali metal fluorides, alkaline earth metal fluorides, and the like, organic fine particles as described in paragraphs [0020] to [0038] in JP1999-3820A (JP-H11-3820A), and the like), a silane coupling agent, a skidding agent, a surfactant, and the like as additives other than the above, and can be configured as shown in FIG. 5.

In a case in which the low refractive index layer is located at the bottom layer of the outermost layer, the low refractive index layer may be formed by a vapor deposition method (a vacuum deposition method, a sputtering method, an ion plating method, a plasma CVD method, and the like). A coating method is preferred since the low refractive index layer can be manufactured at low cost.

The film thickness of the low refractive index layer is preferably 30 nm to 200 nm, more preferably 50 nm to 150 nm, and most preferably 60 nm to 120 nm.

Furthermore, a hard coating layer, a moisture barrier, a forward scattering layer, a primer layer, an antistat layer, a basecoat layer, a protective layer, and the like may be provided.

<Light Shielding Portion>

In the invention, a light shielding proportion may be provided between the image display panel and the phase difference plate. Provision of a light shielding portion can prevent left-eye and right-eye images from passing through a plurality of phase difference areas, and can reduce crosstalk. Examples of the light shielding portion that can be used include a variety of well-known light shielding portions, such as black matrix.

<Liquid Crystalline Cell>

The liquid crystalline cell used in the 3D image display apparatus that is used in the 3D image display system of the invention is preferably a VA mode, an OCB mode, an IPS mode, or a TN mode, but is not limited thereto.

In the liquid crystalline cell in the TN mode, when no voltage is applied, the rod-shaped liquid crystalline molecules are oriented substantially horizontally, and, furthermore, twisted at 60° to 120°. The liquid crystalline cell in the TN mode is most widely used as a color TFT liquid crystal display apparatus, and described in many publications.

In the liquid crystalline cell in the VA mode, rod-shaped liquid crystalline molecules are oriented substantially vertically when no voltage is applied. The liquid crystalline cell in the VA mode includes (1) a liquid crystalline cell in the VA mode in a narrow definition in which rod-shaped liquid crystalline molecules are oriented substantially vertically when no voltage is applied, and substantially horizontally when voltage is applied (described in JP1990-176625A (JP-H2-176625A)), (2) a liquid crystalline cell (in the MVA mode) for which the VA mode is made into multi domains for view angle enlargement (described in SID97, Digest of Tech. Papers (Proceedings) 28 (1997) 845), (3) a liquid crystalline cell in a mode in which rod-shaped liquid crystalline molecules are oriented substantially vertically when no voltage is applied, and twisted so as to be oriented into multi domains when voltage is applied (n-ASM mode) (described in the Proceedings of Japanese Liquid Crystal Society 58 to 59 (1998)), and (4) a liquid crystalline cell in a survival mode (presented in the LCD International 98). In addition, the liquid crystal may have any of a patterned vertical alignment (PVA) type, an optical alignment type, and polymer-sustained alignment (PSA). The details of the above modes are described in JP2006-215326A and JP2008-538819A.

In the liquid crystalline cell in the IPS mode, the rod-shaped liquid crystal molecules are disposed substantially in parallel to the substrate, and, when a parallel electric field is applied to the substrate surface, the liquid crystal molecules respond in a planar manner. The IPS mode displays black in an electric field-free state, and the transmission axes of a pair of top and bottom polarization plates cross orthogonally with respect to each other. A method in which leaked light in an inclined direction while displaying black is reduced using an optical retardation sheet so as to improve the view angle is disclosed in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), JP1998-307291A (JP-H10-307291A), and the like.

<Polarization Plate for the 3D Image Display System>

In the stereoscopic image display system of the invention, images are recognized through a polarization plate in order particularly to enable an observer to recognize stereoscopic images that are termed 3D images. An aspect of the polarization plate is polarized glasses. In an aspect in which right-eye and left-eye circularly polarized images are formed using a phase difference plate, circularly polarized glasses are used, and, in an aspect in which linearly polarized images are formed, linear glasses are used. The polarization plate is preferably configured so that right-eye image light rays ejected from one of the first and second phase difference areas of the optically anisotropic layer are allowed to pass through the right-eye glass, but shielded at the left-eye glass, and left-eye image light rays ejected from the other of the first and second phase difference areas are allowed to pass through the left-eye glass, but shielded at the right-eye glass.

The polarized glasses include a phase difference function layer and a linear polarizer so as to form polarized glasses. Meanwhile, other members having the same function as the linear polarizer may be used.

The specific configuration of the 3D image display system of the invention including the polarization glasses will be described. Firstly, the phase difference plate is provided with the first phase difference areas and the second phase difference areas having different polarization conversion functions on a plurality of first lines and a plurality of second lines that are alternately repeated in the image display panel (for example, odd number lines and even number lines in the horizontal direction when the lines are in the horizontal direction, and odd number lines and even number lines in the vertical direction when the lines are in the vertical direction). In a case in which circularly polarized light is used for display, the phase difference at the first phase difference areas and the second phase difference areas is preferably λ/4, and it is more preferable that the retarded axes of the first phase difference areas and the second phase difference areas cross orthogonally with respect to each other.

In a case in which circularly polarized light is used, the phase difference values of the first phase difference areas and the second phase difference areas are all set to λ/4, right-eye images are displayed at odd number lines in the image display panel, when the retarded axes of the odd number line phase difference areas are in a 45 degree direction, λ/4 plates are preferably disposed at both the right-eye glass and the left-eye glass of the polarization glasses, and the retarded axis of the λ/4 plate of the right-eye glass of the polarization glasses simply needs to be fixed at specifically approximately 45 degrees. In addition, in the above situation, similarly, left-eye images are displayed at even number lines in the image display panel, and the retarded axis of the left-eye glass of the polarization glasses simply needs to be fixed at specifically approximately 135 degrees when the retarded axes of the even number line phase difference areas are in a 135 degree direction.

Furthermore, the angle of the retarded axis fixed by the right-eye glass in an example of the above case is preferably close to accurately 45 degrees in the horizontal direction from the standpoint that image light is once ejected as circularly polarized light at the patterning phase difference film, and the polarization state is returned to the original using the polarization glasses. In addition, the angle of the retarded axis fixed by the left-eye glass is preferably close to accurately horizontal 135 degrees (or −45 degrees).

In addition, for example, in a case in which the image display panel is a liquid crystal display panel, it is preferable that the direction of the absorption axis of the front-side polarization plate of the liquid crystal display panel be ordinarily in the horizontal direction, and the absorption axis of the linear polarizer of the polarized glasses be in a direction orthogonal to the direction of the absorption axis of the front-side polarization plate, and the absorption axis of the linear polarizer of the polarization glasses is more preferably in a vertical direction.

In addition, the direction of the absorption axis of the front-side polarization plate of the liquid crystal display panel and the respective retarded axes of the odd number line phase difference areas and the even number phase difference areas in the patterning phase difference film preferably form 45 degrees in terms of the polarization conversion efficiency.

Meanwhile, a preferred disposition of such polarization glasses, the patterning phase difference film, and the liquid crystal display apparatus is disclosed in, for example, JP2004-170693 A.

Examples of the polarization glasses include the polarization glasses as described in JP2004-170693A and accessories of ZM-M220 W, manufactured by Zalman Tech Co., which is a commercially available product.

### EXAMPLES

Hereinafter, the invention will be described more specifically based on examples. Materials, amounts used, proportions, treatment contents, treatment sequences, and the like as shown in the following examples can be appropriately modified within the scope of the purport of the invention. Therefore, the scope of the invention is not interpreted to be limited to specific examples as shown below.

(Preparation of an Adhesive)

A urethane (meth)acrylate-based macromonomer A (glass transition temperature: −32° C., number of functional groups: 2), for which the hydroxyl group-containing (meth)acrylate compound (monomer) was 2-hydroxyethyl acrylate, the polyisocyanate compound (diisocyanate) was isophorone diisocyanate, and the polyol compound (diol) was polypropylene glycol 1000 (mass average molecular weight: 1586, number average molecular weight: 1447), was synthesized as follows:

(Method of Preparing a Urethane Acrylate A)

A droplet of dibutyltin laurate was added to 2 moles of isophorone diisocyanate, the mixture was stirred at 70 degrees, 1 mole of polypropylene glycol was added dropwise, the mixture was stirred, reacted for 3 hours, then, 2 moles of hydroxylethyl acrylate was added dropwise, and the mixture was stirred for 3 hours, thereby producing a urethane acrylate A.

The mass average molecular weights and number average molecular weights of the raw materials were measured as follows:

0.1% by mass of a part of polypropylene glycol 1000 (manufactured by Wako Pure Chemical Industries, Ltd.) was dissolved in tetrahydrofuran (THF), the mass average molecular weight and the number average molecular weight were measured using gel permeation chromatography (GPC), and the mass average molecular weight was 1586, and the number average molecular weight was 1447. In the invention, the mass average molecular weight and the number average molecular weight were values obtained using polystyrene as a standard substance.

The glass transition temperature of the urethane (meth)acylate-based macromonomer was measured using differential scanning calorimetry (DSC).

An adhesive composition corresponding to the following was manufactured using the urethane (meth)acrylate-based macromonomer.

TABLE 1

| Ultra- | Urethane | | |
|---|---|---|---|
| violet | (meth)acrylate- | | Volume |
| curable | based | Photopolymerization | shrinkage |
| composition | macromonomer | initiator | rate |
| A | Urethane acrylate A | 2-methyl-4′- | 1.5% |
| | 6.0 g | (methylthio)-2-morpholin | |
| | | opropiophenone 0.6 g | |

### Example 1

<<Manufacturing of Pattern Polarization Plate A>>

<Manufacturing of a Transparent Supporting Body A>

An 80 μm-thick TAC film (manufactured by Fuji Film Holdings Corporation, Re/Rth=2/40 at 550 nm) was used as a supporting body A for a surface layer and an optically anisotropic layer.

<<Alkali Saponification Treatment>>

The transparent supporting body A was made to pass through dielectric heating rolls at a temperature of 60° C. so as to increase the temperature of the film surface to 40° C., then, an alkali solution having the following composition was coated on one surface of the film using a bar coater at a coating amount of 14 ml/m², the film was heated to 110° C., and transported for 10 seconds under a steam-type far-infrared heater manufactured by Noritake Co., Ltd. Subsequently, 3 ml/m² of pure water was coated using the bar coater in a similar manner. Next, water washing using a fountain coater and drainage using an air knife was repeated three times, and then the film was transported and dried in a drying zone at 70° C. for 10 seconds, thereby manufacturing an alkali-saponified transparent supporting body A.

Composition of the alkali solution (parts by mass)

| | | |
|---|---|---|
| Potassium hydroxide | 4.7 | parts by mass |
| Water | 15.8 | parts by mass |
| Isopropanol | 63.7 | parts by mass |
| Surfactant SF-1: C₁₄H₂₉O (CH₂CH₂O)₂₀H | 1.0 | part by mass |
| Propylene glycol | 14.8 | parts by mass |

<Manufacturing of a Rubbing Oriented Film-Attached Transparent Supporting Body>

The following composition for a rubbing oriented film was prepared, made to pass through a polypropylene filter having a pore diameter of 0.2 μm, and used as a coating fluid for the rubbing oriented film. The coating fluid was coated on the surface of the transparent supporting body using a No. 8 bar, and dried at 100° C. for one minute. Next, a 100 μm×100 μm grid mask was disposed on the rubbing oriented film, ultraviolet rays were irradiated to a UV-C area for 4 seconds using an air cooling metal halide lamp having an illuminance of 2.5 mW/cm² (manufactured by Eye Graphics Co., Ltd.), and a photo acid generating agent was decomposed so as to generate an acidic compound, thereby manufacturing an oriented film for the first phase difference areas. The irradiated portion (the first phase difference areas) and non-irradiated portion (the second phase difference areas) of the formed oriented film were respectively analyzed using TOF-SIMS (time-of-flight secondary ion mass spectrometry, TOF-SIMS V, manufactured by ION-TOF GmbH), the ratio of the photo acid generating agent S-1 present in the corresponding oriented film between the first phase difference areas and the second phase difference areas was 8 to 92. After that, a rubbing treatment was carried out for one cycle in a single direction at 500 rpm so as to manufacture a rubbing oriented film-attached glass supporting body. Meanwhile, the glass supporting body had a Re (550) of 0 nm and a Rth of 0 nm, and the thickness of the oriented film was 0.5 μm.

Composition of the oriented film

| | | |
|---|---|---|
| Polymer material for the oriented film | 3.9 | parts by mass |
| (PVA 103, polyvinyl alcohol manufactured | | |
| by Kuraray Co., Ltd.) | | |
| Photo acid generating agent (S-1) | 0.1 | parts by mass |
| Methanol | 36 | parts by mass |
| Water | 60 | parts by mass |

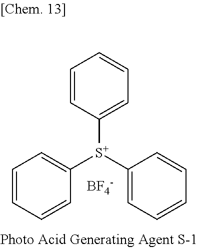

<Manufacturing of a Patterned Optically Anisotropic Layer>

The following composition for an optically anisotropic layer was prepared, made to pass through a polypropylene filter having a pore diameter of 0.2 μm, and used as a coating fluid for the optically anisotropic layer. The coating fluid was coated, dried on a film surface at a temperature of 110° C. for 2 minutes so as to be made into a liquid crystalline phase state and uniformly oriented, cooled to 100° C., ultraviolet rays were irradiated for 20 seconds in the air using a 20 mW/cm² air cooling metal halide lamp (manufactured by Eye Graphics Co., Ltd.), and the orientation state was fixed, thereby forming a patterned optically anisotropic layer. The retarded axis direction was in parallel with the rubbing direction, and the discotic liquid crystal was vertically oriented in the mask exposed portion (the first phase difference areas), and the discotic liquid crystal was vertically oriented alternately in the unexposed portion (the second phase difference areas). Meanwhile, the film thickness of the optically anisotropic layer was 0.8 μm.

Composition of the optically anisotropic layer

| | | |
|---|---|---|
| Discotic liquid crystal E-1 | 100 | parts by mass |
| Oriented film surfactant (II-1) | 3.0 | parts by mass |
| Air surfactant (P-1) | 0.4 | parts by mass |
| Polymerization initiator | 3.0 | parts by mass |
| (IRGACURE 907, manufactured by | | |
| Ciba Specialty Chemicals Inc.) | | |
| Sensitizer (KAYACURE-DETX, | 1.0 | part by mass |
| manufactured by Nippon Kayaku Co., Ltd.) | | |
| Methyl ethyl ketone | 400 | parts by mass |

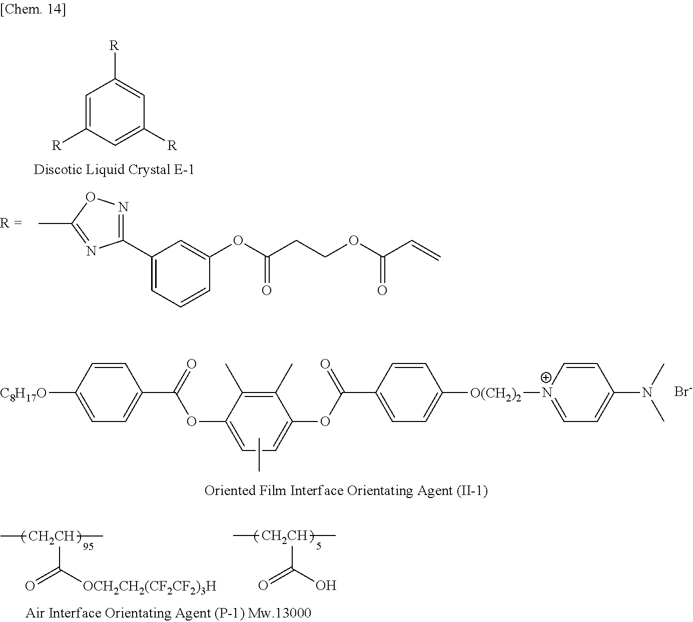

<Formation of the Surface Layer (an Anti-Reflection Layer)>

[Preparation of a Coating Fluid for a Hard Coating Layer]

250 g of a mixture (DPHA, manufactured by Nippon Kayaku Co., Ltd.) of dipentaerythritol pentaacrylate and dipentaerythritol hexacrylate was dissolved in 439 g of an industrial modified ethanol. Furthermore, a solution containing 7.5 g of a photopolymerization initiator (IRGACURE 907, manufactured by Ciba Specialty Chemicals Inc.) and 5.0 g of a sensitizer (KAYACURE-DETX, manufactured by Nippon Kayaku Co., Ltd.) dissolved in 49 g of methyl ethyl ketone was added, the mixture was well stirred, and then made to pass through a 1 μm filter, thereby preparing a coating fluid.

[Preparation of a Coating Fluid for a Low Refractive Index Layer]

(Synthesis of a Perfluoroolefin Copolymer (1))

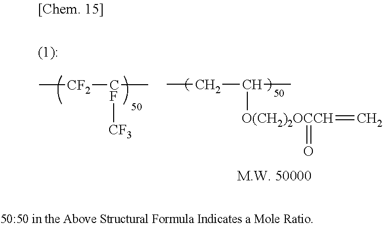

40 ml of ethyl acetate, 14.7 g of hydroxylethyl vinyl ether, and 0.55 g of dilaulroyl peroxide were prepared in a stainless steel stirrer-attached autoclave having a capacity of 100 ml, the air in the system was exhausted, and substituted with nitrogen gas. Furthermore, 25 g of hexafluoropropylene (HFP) was introduced to the autoclave, and the mixture was heated to 65° C. When the temperature in the autoclave reached 65° C., the pressure was 0.53 MPa (5.4 kg/cm²). A reaction continued for 8 hours while the temperature was held, heating was stopped when the pressure reached 0.31 MPa (3.2 kg/cm²), and the mixture was cooled. Unreacted monomer was extracted when the internal temperature was decreased to room temperature, the autoclave was opened, and the reaction solution was taken out. The obtained reaction solution was injected into a significant excess of hexane, and the solvent was removed by decantation, thereby extracting settled polymer. Furthermore, the polymer was dissolved in a small amount of ethyl acetate, and made to settle again from the hexane twice, thereby completely removing the residual monomer. After drying, 28 g of the polymer was obtained. Next, 20 g of the polymer was dissolved in 100 ml of N,N-dimethyl acetamide, 11.4 g of acrylic acid chloride was added dropwise during ice cooling, and the mixture was stirred at room temperature for 10 hours. Ethyl acetate was added to the reaction solution, the mixture was washed using water, an organic layer was extracted, then condensed, and the obtained polymer was made to settle again, thereby producing 19 g of perfluoroolefin copolymer (1). The refractive index of the obtained polymer was 1.422, and the mass average molecular weight was 50000.

[Preparation of a Hollow Silica Particle Dispersion Liquid A]

30 parts by mass of acryloyloxy propyl trimethoxysilane and 1.51 parts by mass of diisopropoxy aluminum ethyl acetate were added to 500 parts by mass of a hollow silica particle fine particle sol (isopropyl alcohol silica sol, CS60-IPA manufactured by Catalysts & Chemicals Ind. Co., Ltd., average particle diameter: 60 nm, shell thickness: 10 nm, silica concentration: 20% by mass, refractive index of silica particles: 1.31), mixed, and then 9 parts by mass of ion exchange water was added. The mixture was reacted at 60° C. for 8 hours, then, cooled to room temperature, and 1.8 parts by mass of acetyl acetone was added, thereby producing a dispersion liquid. After that, while cyclohexanone was added so that the content of the silica content remained almost constant, the solvent was substituted by vacuum distillation at a pressure of 30 Torr, and, finally, 18.2% by mass of a dispersion liquid A was obtained by concentration adjustment. As a result of the gas chromatography, the IPA residual amount of the obtained dispersion liquid A was 0.5% by mass or less.

[Preparation of a Coating Fluid for the Low Refractive Index Layer]

The respective components were mixed as follows, and dissolved in methyl ethyl ketone, thereby manufacturing a coating fluid Ln6 for the low refractive index layer having a solid content concentration of 5% by mass. The % by mass of the respective components below indicates the ratio of the solid contents of the respective components with respect to the total solid content of the coating fluid.

| | | |
|---|---|---|
| P-1: perfluoroolefin copolymer (1) | 15% | by mass |
| DPHA: a mixture of dipentaerythritol | 7% | by mass |
| pentaacrylate and dipentaerythritol | | |
| hexacrylate (manufactured by Nippon | | |
| Kayaku Co., Ltd.) | | |
| MF1: the following fluorine-containing | 5% | by mass |
| unsaturated compound as described in | | |
| the examples of WO2003/022906 (mass | | |
| average molecular weight: 1600) | | |
| M-1: KAYARAD DPHA, manufactured by | 20% | by mass |
| Nippon Kayaku Co., Ltd. | | |
| Dispersion liquid A: a hollow silica | 50% | by mass |
| particle dispersion liquid A (a hollow | | |
| silica particle sol whose surface was | | |
| modified by acryloyloxy propyl | | |
| trimethoxysilane, solid content | | |
| concentration: 18.2%) | | |
| Irg 127: a photopolymerization initiator, | 3% | by mass |
| IRGACURE 127 (manufactured by Ciba | | |
| Specialty Chemicals Inc.) | | |

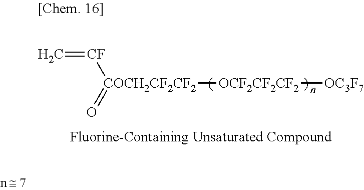

A coating fluid for a hard coating layer having the composition was coated using a bar coater on a surface of the manufactured pattern phase difference plate on which the patterned optically anisotropic layer was not formed. After the coating fluid was dried at 120° C., while nitrogen purging was carried out so that an atmosphere having an oxygen concentration of 1.0% by volume or less was formed, ultraviolet rays having an illuminance of 400 mW/cm² and an irradiance level of 150 mJ/cm² were irradiated using a 160 W/cm air cooling metal halide lamp (manufactured by Eye Graphics Co., Ltd.) so as to cure the coating layer, thereby forming a 6 μm-thick hard coating layer.

Subsequently, the coating fluid for the low refractive index layer was coated using a bar coater. The drying conditions were 120° C. and 30 seconds, and while nitrogen purging was carried out so that an atmosphere having an oxygen concentration of 0.1% by volume or less was formed, ultraviolet rays having an illuminance of 600 mW/cm² and an irradiance level of 600 mJ/cm² were irradiated using a 240 W/cm air cooling metal halide lamp (manufactured by Eye Graphics Co., Ltd.) so as to cure the coating layer, thereby forming a 0.1 μm-thick low refractive index layer.

<Manufacturing of a Polarization Plate A>

A TAC film (manufactured by Fuji Film Holdings Corporation, Re/Rth=2/40 at 550 nm) was used as a protective film for the polarization plate, and the surface was subjected to an alkali saponification treatment. The film was immersed in a 1.5N aqueous solution of sodium hydroxide at 55° C. for 2 minutes, washed in a water-washing tank at room temperature, and neutralized using 0.1N sulfuric acid at 30° C. Again, the film was washed in the water-washing tank, and, furthermore, dried using 100° C. hot air.

Subsequently, an 80 μm-thick roll-shaped polyvinyl alcohol film was continuously stretched to five times the original length in an aqueous solution of iodine, and dried, thereby producing a 20 μm-thick polarization film. The alkali-saponified TAC film and a similarly alkali-saponified VA phase difference film (manufactured by Fuji Film Holdings Corporation, Re/Rth=50/125 at 550 nm) were adhered between the polarization films so that the saponified surfaces faced the polarization films using a 3% aqueous solution of polyvinyl alcohol (PVA-117H, manufactured by Kuraray Co., Ltd.) as an adhesive, thereby manufacturing a polarization plate A in which the TAC film and the VA phase difference film served as the protective film for the polarization films. The angle formed by the retarded axis of the VA phase difference film and the transmission axis of the polarization film at this time was made to be 45 degrees.

### <Manufacturing of a Patterned Polarization Plate A>

A surface of the TAC film in the manufactured polarization plate and the surface of the patterned optically anisotropic layer in the manufactured surface layer-attached pattern phase difference plate were adhered to each other through the manufactured adhesive composition so as to manufacture a patterned polarization plate A having the configuration of FIG. 1A.

### Example 2

<<Manufacturing of a Patterned Polarization Plate B>>

<Manufacturing of the Surface Layer>

A surface film was formed in the same manner as in Example 1 using the supporting body A which was used to manufacture the pattern phase difference plate in Example 1 (the 80 μm-thick TAC film (manufactured by Fuji Film Holdings Corporation, Re/Rth=2/40 at 550 nm)) as a supporting body. The surface film was manufactured in the above manner.

<Manufacturing of a Polarization Plate B>

An 80 μm-thick roll-shaped polyvinyl alcohol film was continuously stretched to five times the original length in an aqueous solution of iodine, and dried, thereby producing a 20 μm-thick polarization film. The patterned transparent supporting body of the optically anisotropic layer manufactured in Example 1 and a similarly alkali-saponified VA phase difference film as Example 1 (manufactured by Fuji Film Holdings Corporation, Re/Rth=50/125 at 550 nm) were adhered between the polarization films so that the saponified surfaces faced the polarization films using a 3% aqueous solution of polyvinyl alcohol (PVA-117H, manufactured by Kuraray Co., Ltd.) as an adhesive, thereby manufacturing a polarization plate B in which the optically anisotropic layer, the supporting body thereof, and the VA phase difference film served as the protective films for the polarization films. The angle formed by the retarded axis of the VA phase difference film and the transmission axis of the polarization film at this time was made to be 45 degrees.

<Manufacturing of the Patterned Polarization Plate B>

A surface of the patterned optically anisotropic layer in the manufactured polarization plate B and the rear surface (the surface on which the surface layer was not formed) of the supporting body in the manufactured surface film were adhered to each other through the manufactured adhesive composition so as to manufacture a patterned polarization plate B having the configuration of FIG. 1B.

### Example 3

<<Manufacturing of a Patterned Polarization Plate C>>

An 80 μm-thick roll-shaped polyvinyl alcohol film was continuously stretched to five times the original length in an aqueous solution of iodine, and dried, thereby producing a 20 μm-thick polarization film. The patterned optically anisotropic layer manufactured in Example 1, the optically anisotropic layer of the surface layer-attached transparent supporting body, and a VA phase difference film that was alkali-saponified in the same manner as in Example 1 (manufactured by Fuji Film Holdings Corporation, Re/Rth=50/125 at 550 nm) were adhered between the polarization films so that the saponified surfaces faced the polarization films using a 3% aqueous solution of polyvinyl alcohol (PVA-117H, manufactured by Kuraray Co., Ltd.) as an adhesive, thereby manufacturing a polarization plate C having the configuration of FIG. 1C in which the optically anisotropic layer, the supporting body thereof, and the VA phase difference film served as the protective films for the polarization films. The angle formed by the retarded axis of the VA phase difference film and the transmission axis of the polarization film at this time was made to be 45 degrees.

### Comparative Example 1

<<Manufacturing of a Patterned Polarization Plate D>>

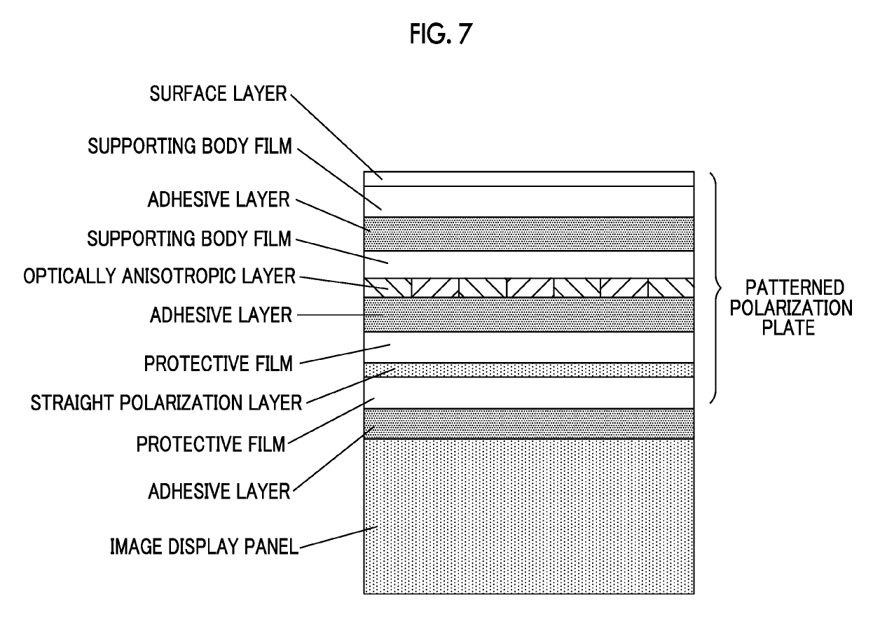

The surface film manufactured in Example 2, a pattern phase difference plate having the patterned optically anisotropic layer manufactured in Example 1 (on which the surface layer was not formed), and the polarization plate A manufactured in Example 1 were adhered through adhesive sheets (manufactured by Lintec Corporation) so as to manufacture a patterned polarization plate D having the configuration of FIG. 7. Since, in the patterned polarization plate D, supporting body films were disposed between the surface layer and the patterned optically anisotropic layer respectively, the former supporting film and the latter protective film were disposed between the patterned optically anisotropic layer and the linear polarization layer, and the respective films were adhered using adhesive sheets, the configuration of the patterned polarization plate D included two adhesive layers.

[Evaluation]

With respect to the respective patterned polarization plates as manufactured in the above, reworkability and occurrence of crosstalk were evaluated as follows, and the results are shown in the following table.

<Reworkability>

The respective 250×250 patterned polarization plates A were adhered to a 300×300 glass substrate (1.1 mm thick) through the manufactured adhesive composition so as to manufacture adhered products. Meanwhile, when the plates A were adhered to the glass substrate, the VA phase difference films present on the outermost surfaces of the respective patterned polarization plates were adhered facing the glass substrate surface. 20 pieces of the adhered products were manufactured, and peeling tests (operations in which a corner portion was partially separated using a cutter blade, and then the portion was gripped and pulled off for separation) were carried out after adhesion. The same operation was carried out for the patterned polarization plates B to D.

<Crosstalk>

3D display image qualities were evaluated using the patterned polarization plates A to D respectively. The polarization plate disposed on the front surface of a commercially available 22-inch wide monitor (FlexScan S2202W-T, manufactured by EIZO Nanao Corporation) was carefully peeled off, and the respective patterned polarization plates were adhered through the manufactured adhesive composition. Meanwhile, when the plates were adhered, the VA phase difference films present on the outermost surfaces of the respective patterned polarization plates were adhered facing the monitor. The adhesion was evaluated by comparing the edge of the pattern optical phase difference and the pixel edge of the liquid crystal panel through polarization observation using an inspection microscope (FS300, manufactured by Mitutoyo Corporation), and computing the adhesion accuracy.

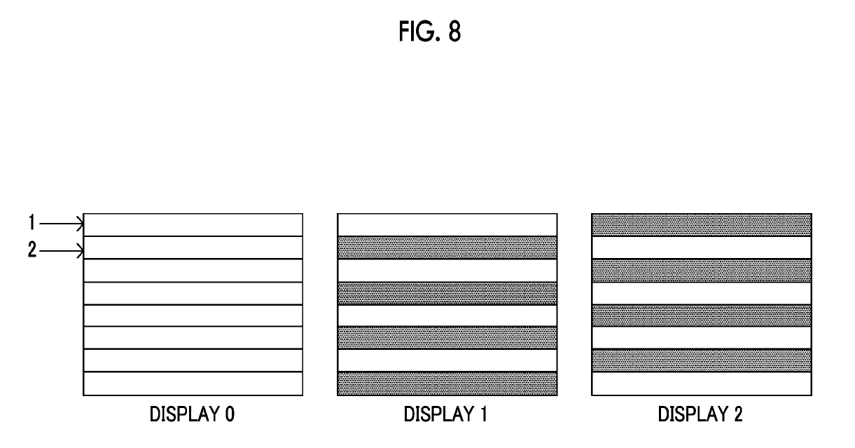

In the liquid crystal display panel of the liquid crystal display apparatus to which the patterned polarization plate was adhered, areas through which right-eye images in the patterning phase difference layer passed (the first phase difference areas) were disposed on the odd number lines (horizontal direction) in the liquid crystal display panel, and areas through which left-eye images in the patterning phase difference layer passed (the second phase difference areas) were disposed on the even number lines as shown in FIG. 8. On the screen, three patterns of a “display 0” in which all lines displayed white, a “display 1” in which the odd number lines displayed black and the even number lines displayed white, and a “display 2” in which the odd number lines displayed white, and the even number lines displayed black were displayed, and the intensity of light rays that transmitted the right and left glasses was measured at the front surface, in the 45 degree-inclined direction from the front surface, and in the polar angle 5° direction. At this time, the crosstalk amount at the respective places can be obtained as an average value of crosstalk (at the right eye) and crosstalk (at the left eye) obtained by computation using the following formulae (1) and (2).

Crosstalk (at the right eye)=(right-eye glass-transmitted light in display 2)/(right-eye glass-transmitted light in display 0)×100% Formula (1)

Crosstalk (at the left eye)=(left-eye glass-transmitted light in display 1)/(left-eye glass-transmitted light in display 0)×100% Formula (2):

TABLE 2

| | Reworkability | | | |
|---|---|---|---|---|
| | evaluation | | | |
| | Number of poor | Crosstalk evaluation | | |
| | separation | Crosstalk | Crosstalk | |
| | occurrences | (front | (±5 | Matching |
| Configuration | caused | surface) | degrees) | accuracy |
| Example 1 | 1/20 | 1 | 3 | ≦±5 μm |
| Example 2 | 1/20 | 1 | 3 | ≦±5 μm |
| Example 3 | 0/20 | 1 | 2 | ≦±5 μm |
| Comparative | 5/20 | 1.5 | 5 | ≦±5 μm |
| Example 1 | | | | |

In all of the patterned polarization plates of the examples of the invention, the number of occurrences of poor separation was one or less in 20 times of the separation operation, and the plates could be separated and reused even when the location deviated during adhesion, and therefore it can be understood that the reworkability was excellent.

On the other hand, in the patterned polarization plate of Comparative Example 1, separation from the glass surface was difficult, poor separation in which some constituent members could not be well separated and remained in an adhesion state occurred five times out of 20 times, and it can be understood that the reworkability was poor.

In addition, it was found that the 3D image display apparatuses of the examples had favorable crosstalk not only at the front surface but also in the inclined direction.

### Example 4

<<Manufacturing of a Patterned Polarization Plate E>>

A patterned polarization plate E having the configuration of FIG. 1A was manufactured in the same manner as in Example 1 except that an oriented film-attached transparent supporting body and a pattern phase difference plate were manufactured as follows.

<Manufacturing of an Oriented Film-Attached Transparent Supporting Body>

A photo oriented film (LIA series, manufactured by DIC Corporation) was coated on the saponified surface of the manufactured supporting body A through bar coating, then, subjected to a drying treatment at 100° C. for 1 minute. The film thickness of the obtained oriented film was approximately 100 nm. After that, polarized exposure irradiation was carried out twice-through a photo mask (stripe pattern mask: the light shielding width and the opening width were 282 μm), and a photo orientation treatment was carried out. Here, a light source having an irradiance level of the irradiated polarized light of 200 mJ (365 nm) and a degree of polarization of 15:1 was used.

<Manufacturing of a Pattern Phase Difference Plate>

The coating fluid for the optically anisotropic layer containing a liquid crystalline compound of a RM series, manufactured by Merck & Co, Inc., dissolved in methyl ethyl ketone was coated on the oriented film using a bar coater so that the film thickness of the optically anisotropic layer became 0.9 μm. Next, the coating fluid was heated and matured for 2 minutes at the surface temperature of 110° C., then, cooled to 80° C., ultraviolet rays were irradiated for 20 seconds in the air using a 20 mW/cm² air cooling metal halide lamp (manufactured by Eye Graphics Co., Ltd.), and the orientation state was fixed, thereby forming a patterned optically anisotropic layer. The retarded axis direction was in parallel with the orientation direction, and the discotic liquid crystal was vertically oriented in the mask exposed portion (the first phase difference areas), and the discotic liquid crystal was vertically oriented orthogonally in the unexposed portion (the second phase difference areas). Meanwhile, as a result of a measurement, the retardation in the inner surface direction of the optically anisotropic layer was 125 nm. A pattern phase difference plate was manufactured in the above manner.

### Example 5

<<Manufacturing of a Patterned Polarization Plate F>>

In Example 2, a patterned polarization plate F having the configuration of FIG. 1B was manufactured in the same manner as in Example 2 except that the pattern phase difference plate was changed to the patterned optically anisotropic layer manufactured in Example 4.

### Example 6

<<Manufacturing of a Patterned Polarization Plate G>>

An 80 μm-thick roll-shaped polyvinyl alcohol film was continuously stretched to five times the original length in an aqueous solution of iodine, and dried, thereby producing a 20 μm-thick polarization film. The patterned optically anisotropic layer manufactured in Example 4, the optically anisotropic layer of the surface layer-attached transparent supporting body, and a VA phase difference film that was alkali-saponified in the same manner as in Example 1 (manufactured by Fuji Film Holdings Corporation, Re/Rth=50/125 at 550 nm) were adhered between the polarization films so that the saponified surfaces faced the polarization films using a 3% aqueous solution of polyvinyl alcohol (PVA-117H, manufactured by Kuraray Co., Ltd.) as an adhesive, thereby manufacturing a polarization plate C having the configuration of FIG. 1C in which the optically anisotropic layer, the supporting body thereof, and the VA phase difference film served as the protective film of the polarization films. The angle formed by the retarded axis of the VA phase difference film and the transmission axis of the polarization film at this time was made to be 45 degrees.

### Comparative Example 2

<<Manufacturing of a Patterned Polarization Plate H>>

In Comparative Example 1, a patterned polarization plate H having the configuration of FIG. 7 was manufactured in the same manner as in Comparative Example 1 except that the pattern phase difference plate having the patterned optically anisotropic layer manufactured in Example 1 was changed to the patterned optically anisotropic layer manufactured in Example 4.

For Examples 4 to 6 and Comparative Example 2, the same evaluation as in Example 1 was carried out, and it could be confirmed that the patterned polarization plates E to G were superior in the reworkability and the crosstalk properties in an inclined direction to the patterned polarization plate H of Comparative Example.

What is claimed is:

1. A 3D image display apparatus comprising:
an image display panel; and
a patterned polarization plate disposed on an observation side of the image display panel,
wherein the patterned polarization plate has at least a surface layer, a patterned optically anisotropic layer, and a linear polarization layer arranged sequentially from a surface on the observation side,
the patterned polarization plate has at most one film between the surface layer and the patterned optically anisotropic layer and between the patterned optically anisotropic layer and the linear polarization layer respectively,
the patterned polarization plate includes at most one adhesive layer, and
the adhesive layer is provided between the image display panel and the patterned polarization plate.

2. The 3D image display apparatus according to claim 1, wherein one film that supports the patterned optically anisotropic layer and the surface layer is provided between the patterned optically anisotropic layer and the surface layer.

3. The 3D image display apparatus according to claim 1, wherein one film that supports the patterned optically anisotropic layer and protects the linear polarization layer is provided between the patterned optically anisotropic layer and the linear polarization layer.

4. The 3D image display apparatus according to claim 2, wherein one film that supports the patterned optically anisotropic layer and protects the linear polarization layer is provided between the patterned optically anisotropic layer and the linear polarization layer.

5. The 3D image display apparatus according to claim 1, wherein neither a film nor an adhesive layer is provided between the patterned optically anisotropic layer and the linear polarization layer.

6. The 3D image display apparatus according to claim 2, wherein neither a film nor an adhesive layer is provided between the patterned optically anisotropic layer and the linear polarization layer.

7. The 3D image display apparatus according to claim 1,
wherein the patterned optically anisotropic layer includes first phase difference areas and second phase difference areas having mutually different inner surface retarded axis directions, the first and second phase difference areas are alternately disposed in the surface of the patterned optically anisotropic layer, and
the surface layer has an anti-reflection layer.

8. The 3D image display apparatus according to claim 2,
wherein the patterned optically anisotropic layer includes first phase difference areas and second phase difference areas having mutually different inner surface retarded axis directions, the first and second phase difference areas are alternately disposed in the surface of the patterned optically anisotropic layer, and
the surface layer has an anti-reflection layer.

9. The 3D image display apparatus according to claim 5, wherein the inner surface retarded axis directions of the first and second phase difference areas cross orthogonally with respect to each other, and angles between the retarded axis directions of the first and second phase difference areas and an absorption axis direction of the linear polarization layer are ±45° respectively.

10. The 3D image display apparatus according to claim 1, wherein left-eye image light and right-eye image light which have passed the patterned polarization plate are circularly polarized types of light rotated in mutually different directions.

11. The 3D image display apparatus according to claim 1, wherein the at most one film includes a cellulose derivative.

12. The 3D image display apparatus according to claim 1, wherein the at most one film satisfies the following formula (I):
0≦Re(550)≦10 (I)
wherein Re(550) indicates the inner surface retardation at a wavelength of 550 nm.

13. The 3D image display apparatus according to claim 2, wherein the at most one film satisfies the following formula (1):
0≦Re(550)≦10 (I)
wherein Re(550) indicates the inner surface retardation at a wavelength of 550 nm.

14. The 3D image display apparatus according to claim 1, wherein the patterned optically anisotropic layer is formed by fixing the orientation state of a composition including a liquid crystalline compound.

15. The 3D image display apparatus according to claim 1, wherein the surface layer has an anti-reflection layer containing a fluorine compound.

16. The 3D image display apparatus according to claim 1 further comprising a light shielding portion for preventing left-eye images and right-eye images displayed on the image display panel from passing through a plurality of phase difference areas.

17. The 3D image display apparatus according to claim 1, wherein the adhesive layer contains a polyol compound, and the glass transition temperature is room temperature or lower.

18. The 3D image display apparatus according to claim 1, wherein the image display panel has a liquid crystalline cell.

19. A patterned polarization plate for a 3D image display apparatus comprising at least:
a surface layer;
a patterned optically anisotropic layer; and
a linear polarization layer,
at most one film provided between the surface layer and the patterned optically anisotropic layer and between the patterned optically anisotropic layer and the linear polarization layer respectively, and
at most one adhesive layer.

20. A stereoscopic image display system comprising at least:
the 3D image display apparatus according to claim 1; and
a second polarization plate disposed on an observer side of the 3D image display apparatus,
wherein stereoscopic images are observed through the second polarization plate.
